(19) United States
(12) Patent Application Publication
(10) Pub. No.: US 2025/0318611 A1
(43) Pub. Date: Oct. 16, 2025

(54) TECHNIQUES FOR MANUFACTURING A WEARABLE DEVICE USING VACUUM OR PRESSURE-FORMED DOMES

(71) Applicant: Oura Health Oy, Oulu (FI)

(72) Inventors: Antti Kalevi Lämsä, Oulu (FI); Mika Petteri Kangas, Oulu (FI); Jouni Juhani Huopana, Oulu (FI)

(21) Appl. No.: 19/171,861

(22) Filed: Apr. 7, 2025

Related U.S. Application Data
(60) Provisional application No. 63/632,431, filed on Apr. 10, 2024.

(51) Int. Cl. A44C 9/00; B29D 99/00

(52) U.S. Cl. CPC A44C 9/0053; B29D 99/0082

(57) ABSTRACT

Methods, systems, and devices for manufacturing a wearable device are described. Techniques described herein may enable manufacture of wearable devices by vacuum and/or pressure-forming protrusions to cover and protect components (e.g., sensors, charging components) of a wearable device. For example, a moldable material may be heated then vacuum and/or pressure-formed in a mold to form the protrusions. The moldable material may be optically clear (e.g., transparent), a colored translucent, or opaque material. In some examples, the protrusions may be unfilled or may be filled with another optically clear material. For example, a manufacturing process may include fully filling the protrusions with the optically clear material through a hole in the protrusions or a hole in one or more other components of the wearable device. Additionally, or alternatively, the manufacturing process may include partially filling the protrusions with the optically clear material.

### CROSS-REFERENCE

The present Application for Patent claims the benefit of U.S. Provisional Patent Application No. 63/632,431 by Lämsä et al., entitled “TECHNIQUES FOR MANUFACTURING A WEARABLE DEVICE USING VACUUM-FORMED DOMES” and filed Apr. 10, 2024, which is assigned to the assignee hereof and is hereby expressly incorporated by reference herein in its entirety.

### FIELD OF TECHNOLOGY

The following relates to wearable devices and data processing, including techniques for manufacturing a wearable device using vacuum-formed and/or pressure-formed domes.

### BACKGROUND

Some wearable devices may be configured to collect data from users including temperature data, heart rate data, and the like. In some cases, the overall structure of the wearable device may affect the accuracy of data measurements performed by the wearable device. Additionally, wearable devices may be intended to be worn full-time, and may therefore be subject to constant wear and tear. As such, there is a desire to improve the durability of wearable devices, while also enabling the wearable devices to be manufactured in an efficient and cost-effective manner.

### BRIEF DESCRIPTION OF THE DRAWINGS

FIG. 1 illustrates an example of a system that supports techniques for manufacturing a wearable device using vacuum-formed and/or pressure-formed domes in accordance with aspects of the present disclosure.

FIG. 2 illustrates an example of a system that supports techniques for manufacturing a wearable device using vacuum-formed and/or pressure-formed domes in accordance with aspects of the present disclosure.

FIGS. 3 and 4 show examples of manufacturing diagrams that support techniques for manufacturing a wearable device using vacuum-formed and/or pressure-formed domes in accordance with aspects of the present disclosure.

FIGS. 5 and 6 show example of protrusion diagrams that support techniques for manufacturing a wearable device using vacuum-formed and/or pressure-formed domes in accordance with aspects of the present disclosure.

FIG. 7 shows a flowchart illustrating methods that support techniques for manufacturing a wearable device using vacuum-formed and/or pressure-formed domes in accordance with aspects of the present disclosure.

### DETAILED DESCRIPTION

Some wearable devices may be configured to collect data from users via one or more sensors of the wearable devices (e.g., light-emitting and light receiving components). In some examples, the sensors may be disposed within a housing of the wearable device, such as on a printed circuit board (PCB) disposed between an outer housing and an inner housing of the wearable device. Accordingly, the inner housing of the wearable device (e.g., a portion of the housing facing a tissue of the user when the wearable device is worn by the user) may include one or more apertures (e.g., holes) that may allow light to pass through the inner housing to and from the sensors. Additionally, or alternatively, the wearable devices may include a charging component (e.g., an inductive charging component) that may enable a charger of the wearable device to charge a rechargeable battery of the wearable device. The inner housing may therefore include an aperture for the charging component that enables the charger to inductively charge the wearable device. Light-emitting components and light-receiving components may be understood to be light-transducers. Light-transducers may convert between light and electricity either to provide an electrical output indicative of received light, or provide a light output in response to an electrical signal. A sensor may include one or more light-transducers. The one or more light-transducers of a sensor may include one or more light-emitting components, one or more light-receiving components, or both.

In some examples, the apertures of the wearable device may include optical lenses (e.g., protrusions) that may be molded from an optically clear material (e.g., epoxy) and may cover and protect internal components of the wearable device (e.g., PCB components, sensors, charging components). It has been found that such protrusions may increase contact with the tissue of the user, and therefore improve physiological measurements. For example, in some cases, an outer shell of a wearable device may be manufactured from a metal, plastic, or ceramic material, where the inner shell forming the protrusions is formed via a moldable epoxy material. However, such epoxy components may be difficult and expensive to manufacture due to cracks or bubbles forming in the epoxy material during a manufacturing procedure, as well as tight tolerances that may result in uneven production. Further, a wearable device may be partially (or mostly) manufactured prior to the epoxy molding process, which may result in wasted material if the epoxy molding process is performed incorrectly. Tools and components used to manufacture the epoxy components may be complex and expensive, which may further increase production cost.

Accordingly, techniques described herein may enable cheaper manufacture of wearable devices by vacuum or pressure-forming dome-shaped protrusions to cover and protect internal components of the wearable device (e.g., PCB components, sensors, charging components). For example, a moldable material (e.g., a plastic polymer material such as acrylic or polymethyl methacrylate (PMMA), polycarbonate (PC), polyethylene terephthalate (PETE or PET), or polyamide (PA)) may be heated (e.g., thermal molding) and vacuum-formed (and/or pressure-formed) in a mold to form portions of an inner surface of a wearable device, such as one or more protrusions that cover sensors of the wearable device. The moldable material may form an inner housing of the wearable device, or may be adhered to the inner housing of the wearable device (e.g., prior to vacuum-forming) such that the vacuum-formed and/or pressure-formed protrusions are extruded through apertures of the inner housing of the wearable device. Additionally, or alternatively, the moldable material may be formed around (e.g., partially surrounding) the inner housing. The PCB (e.g., including the one or more sensors and the charging components) and an outer housing of the wearable device may accordingly be adhered to the inner housing and the moldable material. Such a vacuum or pressure-forming production procedure may result in a relatively less expensive and relatively more versatile manufacturing process due to lower costs of materials. Additionally, the moldable material (e.g., foil) may be thinner than some other optically clear materials (e.g., epoxy), which may result in relatively faster charging of the rechargeable battery and an overall lighter and thinner wearable device.

In some aspects, the moldable material used for the vacuum or pressure-forming processes described herein may be optically clear (e.g., in one or more radial locations corresponding to sensors or charging components of the wearable device) or may be a colored translucent material such as a filter (e.g., in one or more radial locations corresponding to charging components of the wearable device) with suitable optical parameters for the wearable device to perform measurements and/or charge the rechargeable battery of the wearable device through the protrusions. The moldable material may be a single continuous piece of moldable material, or may be multiple separate pieces of moldable materials (e.g., a separate piece of moldable material forming each protrusion, or a first piece of moldable forming protrusions over the one or more sensors and a second piece of moldable material forming a protrusion over the charging component).

In some examples, the protrusions formed via the vacuum or pressure-forming processes described herein may be unfilled (e.g., filled with air) or filled with another optically clear material (e.g., epoxy). For example, a manufacturing process may include manufacturing a hole in the vacuum or pressure-formed protrusions (e.g., after forming the protrusions) and filling the protrusions with the optically clear material through the hole after adhering the PCB (e.g., including the one or more sensors and the charging components) to the moldable material. Additionally, or alternatively, the manufacturing process may include filling the protrusions with the optically clear material after adhering the PCB (e.g., including the one or more sensors and the charging components) to the moldable material via one or more holes in an adhering material (e.g., glue), in the PCB, or both. Additionally, or alternatively, the manufacturing process may include partially filling the protrusions with the optically clear material prior to adhering the PCB (e.g., including the one or more sensors and the charging components) to the moldable material.

Aspects of the disclosure are initially described in the context of systems supporting physiological data collection from users via wearable devices. Aspects of the disclosure are further illustrated by and described with reference to manufacturing diagrams, protrusion diagrams, apparatus diagrams, system diagrams, and flowcharts that relate to techniques for manufacturing a wearable device using vacuum-formed and/or pressure-formed domes.

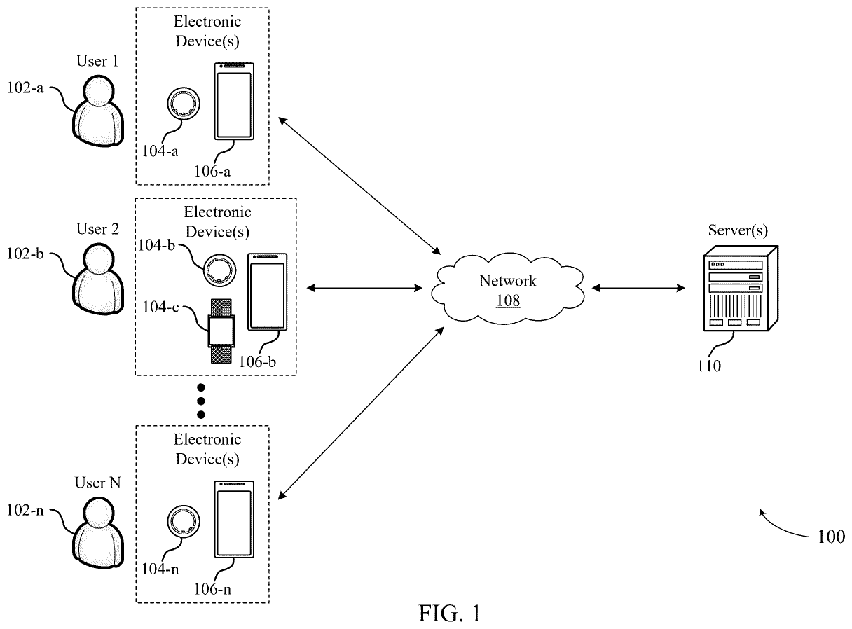

FIG. 1 illustrates an example of a system 100 that supports techniques for manufacturing a wearable device using vacuum-formed and/or pressure-formed domes in accordance with aspects of the present disclosure. The system 100 includes a plurality of electronic devices (e.g., wearable devices 104, user devices 106) that may be worn and/or operated by one or more users 102. The system 100 further includes a network 108 and one or more servers 110.

The electronic devices may include any electronic devices known in the art, including wearable devices 104 (e.g., ring wearable devices, watch wearable devices, etc.), user devices 106 (e.g., smartphones, laptops, tablets). The electronic devices associated with the respective users 102 may include one or more of the following functionalities: 1) measuring physiological data, 2) storing the measured data, 3) processing the data, 4) providing outputs (e.g., via GUIs) to a user 102 based on the processed data, and 5) communicating data with one another and/or other computing devices. Different electronic devices may perform one or more of the functionalities.

Example wearable devices 104 may include wearable computing devices, such as a ring computing device (hereinafter “ring”) configured to be worn on a user's 102 finger, a wrist computing device (e.g., a smart watch, fitness band, or bracelet) configured to be worn on a user's 102 wrist, and/or a head mounted computing device (e.g., glasses/goggles). Wearable devices 104 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 104 may also be attached to, or included in, articles of clothing. For example, wearable devices 104 may be included in pockets and/or pouches on clothing. As another example, wearable device 104 may be clipped and/or pinned to clothing, or may otherwise be maintained within the vicinity of the user 102. Example articles of clothing may include, but are not limited to, hats, shirts, gloves, pants, socks, outerwear (e.g., jackets), and undergarments. In some implementations, wearable devices 104 may be included with other types of devices such as training/sporting devices that are used during physical activity. For example, wearable devices 104 may be attached to, or included in, a bicycle, skis, a tennis racket, a golf club, and/or training weights.

Much of the present disclosure may be described in the context of a ring wearable device 104. Accordingly, the terms “ring 104,” “wearable device 104,” and like terms, may be used interchangeably, unless noted otherwise herein. However, the use of the term “ring 104” is not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 106 may include handheld mobile computing devices, such as smartphones and tablet computing devices. User devices 106 may also include personal computers, such as laptop and desktop computing devices. Other example user devices 106 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 106 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 104, user devices 106) may measure physiological parameters of respective users 102, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 104), mobile device application, or a server computing device may process received physiological data that was measured by other devices.

In some implementations, a user 102 may operate, or may be associated with, multiple electronic devices, some of which may measure physiological parameters and some of which may process the measured physiological parameters. In some implementations, a user 102 may have a ring (e.g., wearable device 104) that measures physiological parameters. The user 102 may also have, or be associated with, a user device 106 (e.g., mobile device, smartphone), where the wearable device 104 and the user device 106 are communicatively coupled to one another. In some cases, the user device 106 may receive data from the wearable device 104 and perform some/all of the calculations described herein. In some implementations, the user device 106 may also measure physiological parameters described herein, such as motion/activity parameters.

For example, as illustrated in FIG. 1, a first user 102-a (User 1) may operate, or may be associated with, a wearable device 104-a (e.g., ring 104-a) and a user device 106-a that may operate as described herein. In this example, the user device 106-a associated with user 102-a may process/store physiological parameters measured by the ring 104-a. Comparatively, a second user 102-b (User 2) may be associated with a ring 104-b, a watch wearable device 104-c (e.g., watch 104-c), and a user device 106-b, where the user device 106-b associated with user 102-b may process/store physiological parameters measured by the ring 104-b and/or the watch 104-c. Moreover, an nth user 102-n (User N) may be associated with an arrangement of electronic devices described herein (e.g., ring 104-n, user device 106-n). In some aspects, wearable devices 104 (e.g., rings 104, watches 104) and other electronic devices may be communicatively coupled to the user devices 106 of the respective users 102 via Bluetooth, Wi-Fi, and other wireless protocols. Moreover, in some cases, the wearable device 104 and the user device 106 may be included within (or make up) the same device. For example, in some cases, the wearable device 104 may be configured to execute an application associated with the wearable device 104, and may be configured to display data via a GUI.

In some implementations, the rings 104 (e.g., wearable devices 104) of the system 100 may be configured to collect physiological data from the respective users 102 based on arterial blood flow within the user's finger. In particular, a ring 104 may utilize one or more light-emitting components, such as LEDs (e.g., red LEDs, green LEDs) that emit light on the palm-side of a user's finger to collect physiological data based on arterial blood flow within the user's finger. In general, the terms light-emitting components, light-emitting elements, and like terms, may include, but are not limited to, LEDs, micro LEDs, mini LEDs, laser diodes (LDs) (e.g., vertical cavity surface- emitting lasers (VCSELs), and the like.

In some cases, the system 100 may be configured to collect physiological data from the respective users 102 based on blood flow diffused into a microvascular bed of skin with capillaries and arterioles. For example, the system 100 may collect PPG data based on a measured amount of blood diffused into the microvascular system of capillaries and arterioles. In some implementations, the ring 104 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the ring 104 has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a ring 104 has been found to exhibit superior performance as compared to wearable devices worn on the wrist, as the ring 104 may have greater access to arteries (as compared to capillaries), thereby resulting in stronger signals and more valuable physiological data.

The electronic devices of the system 100 (e.g., user devices 106, wearable devices 104) may be communicatively coupled to one or more servers 110 via wired or wireless communication protocols. For example, as shown in FIG. 1, the electronic devices (e.g., user devices 106) may be communicatively coupled to one or more servers 110 via a network 108. The network 108 may implement transfer control protocol and internet protocol (TCP/IP), such as the Internet, or may implement other network 108 protocols. Network connections between the network 108 and the respective electronic devices may facilitate transport of data via email, web, text messages, mail, or any other appropriate form of interaction within a computer network 108. For example, in some implementations, the ring 104-a associated with the first user 102-a may be communicatively coupled to the user device 106-a, where the user device 106-a is communicatively coupled to the servers 110 via the network 108. In additional or alternative cases, wearable devices 104 (e.g., rings 104, watches 104) may be directly communicatively coupled to the network 108.

The system 100 may offer an on-demand database service between the user devices 106 and the one or more servers 110. In some cases, the servers 110 may receive data from the user devices 106 via the network 108, and may store and analyze the data. Similarly, the servers 110 may provide data to the user devices 106 via the network 108. In some cases, the servers 110 may be located at one or more data centers. The servers 110 may be used for data storage, management, and processing. In some implementations, the servers 110 may provide a web-based interface to the user device 106 via web browsers.

In some aspects, the system 100 may detect periods of time that a user 102 is asleep, and classify periods of time that the user 102 is asleep into one or more sleep stages (e.g., sleep stage classification). For example, as shown in FIG. 1, User 102-a may be associated with a wearable device 104-a (e.g., ring 104-a) and a user device 106-a. In this example, the ring 104-a may collect physiological data associated with the user 102-a, including temperature, heart rate, HRV, respiratory rate, and the like. In some aspects, data collected by the ring 104-a may be input to a machine learning classifier, where the machine learning classifier is configured to determine periods of time that the user 102-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 102-a via a GUI of the user device 106-a. Sleep stage classification may be used to provide feedback to a user 102-a regarding the user's sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 100 may utilize circadian rhythm-derived features to further improve physiological data collection, data processing procedures, and other techniques described herein. The term circadian rhythm may refer to a natural, internal process that regulates an individual's sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 102-a via the wearable device 104-a. In this example, the circadian rhythm adjustment model may be configured to “weight,” or adjust, physiological data collected throughout a user's natural, approximately 24-hour circadian rhythm. In some implementations, the system may initially start with a “baseline” circadian rhythm adjustment model, and may modify the baseline model using physiological data collected from each user 102 to generate tailored, individualized circadian rhythm adjustment models that are specific to each respective user 102.

In some aspects, the system 100 may utilize other biological rhythms to further improve physiological data collection, analysis, and processing by phase of these other rhythms. For example, if a weekly rhythm is detected within an individual's baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g., in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some aspects, the respective wearable devices 104 of the system 100 may be formed via vacuum-forming and/or pressure-forming processes described herein. For example, the wearable ring devices 104 of the system 100 may include one or more protrusions that are configured to increase tissue contact with the user 102, where the protrusions are formed via a vacuum-forming process and/or a pressure-forming process. For example, a moldable material (e.g., PMMA, PC, PET, and/or PA) may be heated (e.g., thermal molding) and vacuum-formed (and/or pressure-formed) in a mold to form protrusions that extend from an inner shell of the wearable devices 104. For instance, the moldable material may form an inner housing of the wearable device 104, or may be adhered to the inner housing of the wearable device 104 (e.g., prior to vacuum-forming) such that the protrusions are extruded through apertures of the inner housing of the wearable device 104. The PCB (e.g., including the one or more sensors and the charging components) and an outer housing of the ring may accordingly be adhered to the inner housing and the moldable material.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

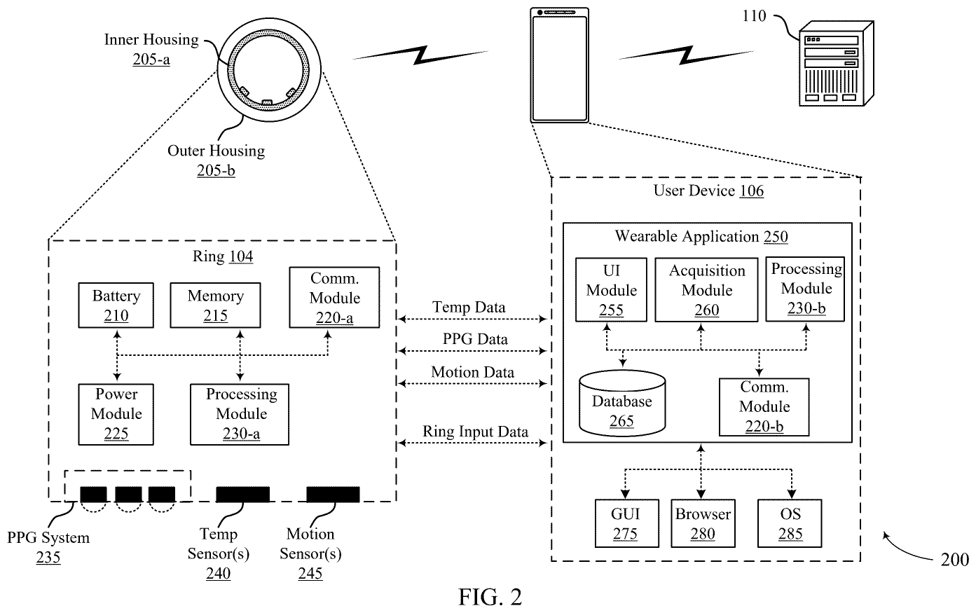

FIG. 2 illustrates an example of a system 200 that supports techniques for manufacturing a wearable device using vacuum-formed and/or pressure-formed domes in accordance with aspects of the present disclosure. The system 200 may implement, or be implemented by, system 100. In particular, system 200 illustrates an example of a ring 104 (e.g., wearable device 104), a user device 106, and a server 110, as described with reference to FIG. 1.

In some aspects, the ring 104 may be configured to be worn around a user's finger, and may determine one or more user physiological parameters when worn around the user's finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 200 further includes a user device 106 (e.g., a smartphone) in communication with the ring 104. For example, the ring 104 may be in wireless and/or wired communication with the user device 106. In some implementations, the ring 104 may send measured and processed data (e.g., temperature data, photoplethysmogram (PPG) data, motion/accelerometer data, ring input data, and the like) to the user device 106. The user device 106 may also send data to the ring 104, such as ring 104 firmware/configuration updates. The user device 106 may process data. In some implementations, the user device 106 may transmit data to the server 110 for processing and/or storage.

The ring 104 may include a housing 205 that may include an inner housing 205-a and an outer housing 205-b. In some aspects, the housing 205 of the ring 104 may store or otherwise include various components of the ring including, but not limited to, device electronics, a power source (e.g., battery 210, and/or capacitor), one or more substrates (e.g., printable circuit boards) that interconnect the device electronics and/or power source, and the like. The device electronics may include device modules (e.g., hardware/software), such as: a processing module 230-a, a memory 215, a communication module 220-a, a power module 225, and the like. The device electronics may also include one or more sensors. Example sensors may include one or more temperature sensors 240, a PPG sensor assembly (e.g., PPG system 235), and one or more motion sensors 245.

The sensors may include associated modules (not illustrated) configured to communicate with the respective components/modules of the ring 104, and generate signals associated with the respective sensors. In some aspects, each of the components/modules of the ring 104 may be communicatively coupled to one another via wired or wireless connections. Moreover, the ring 104 may include additional and/or alternative sensors or other components that are configured to collect physiological data from the user, including light sensors (e.g., LEDs), oximeters, and the like.

The ring 104 shown and described with reference to FIG. 2 is provided solely for illustrative purposes. As such, the ring 104 may include additional or alternative components as those illustrated in FIG. 2. Other rings 104 that provide functionality described herein may be fabricated. For example, rings 104 with fewer components (e.g., sensors) may be fabricated. In a specific example, a ring 104 with a single temperature sensor 240 (or other sensor), a power source, and device electronics configured to read the single temperature sensor 240 (or other sensor) may be fabricated. In another specific example, a temperature sensor 240 (or other sensor) may be attached to a user's finger (e.g., using adhesives, wraps, clamps, spring loaded clamps, etc.). In this case, the sensor may be wired to another computing device, such as a wrist worn computing device that reads the temperature sensor 240 (or other sensor). In other examples, a ring 104 that includes additional sensors and processing functionality may be fabricated.

The housing 205 may include one or more housing 205 components. The housing 205 may include an outer housing 205-b component (e.g., a shell) and an inner housing 205-a component (e.g., a molding). The housing 205 may include additional components (e.g., additional layers) not explicitly illustrated in FIG. 2. For example, in some implementations, the ring 104 may include one or more insulating layers that electrically insulate the device electronics and other conductive materials (e.g., electrical traces) from the outer housing 205-b (e.g., a metal outer housing 205-b). The housing 205 may provide structural support for the device electronics, battery 210, substrate(s), and other components. For example, the housing 205 may protect the device electronics, battery 210, and substrate(s) from mechanical forces, such as pressure and impacts. The housing 205 may also protect the device electronics, battery 210, and substrate(s) from water and/or other chemicals.

The outer housing 205-b may be fabricated from one or more materials. In some implementations, the outer housing 205-b may include a metal, such as titanium, that may provide strength and abrasion resistance at a relatively light weight. The outer housing 205-b may also be fabricated from other materials, such polymers. In some implementations, the outer housing 205-b may be protective as well as decorative.

The inner housing 205-a may be configured to interface with the user's finger. The inner housing 205-a may be formed from a polymer (e.g., a medical grade polymer) or other material. In some implementations, the inner housing 205-a may be transparent. For example, the inner housing 205-a may be transparent to light emitted by the PPG light emitting diodes (LEDs). In some implementations, the inner housing 205-a component may be molded onto the outer housing 205-b. For example, the inner housing 205-a may include a polymer that is molded (e.g., injection molded) to fit into an outer housing 205-b metallic shell.

The ring 104 may include one or more substrates (not illustrated). The device electronics and battery 210 may be included on the one or more substrates. For example, the device electronics and battery 210 may be mounted on one or more substrates. Example substrates may include one or more PCBs, such as flexible PCB (e.g., polyimide). In some implementations, the electronics/battery 210 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 210 to the device electronics.

The device electronics, battery 210, and substrates may be arranged in the ring 104 in a variety of ways. In some implementations, one substrate that includes device electronics may be mounted along the bottom of the ring 104 (e.g., the bottom half), such that the sensors (e.g., PPG system 235, temperature sensors 240, motion sensors 245, and other sensors) interface with the underside of the user's finger. In these implementations, the battery 210 may be included along the top portion of the ring 104 (e.g., on another substrate).

The various components/modules of the ring 104 represent functionality (e.g., circuits and other components) that may be included in the ring 104. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 215 (memory module) of the ring 104 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 215 may store any of the data described herein. For example, the memory 215 may be configured to store data (e.g., motion data, temperature data, PPG data) collected by the respective sensors and PPG system 235. Furthermore, memory 215 may include instructions that, when executed by one or more processing circuits, cause the modules to perform various functions attributed to the modules herein. The device electronics of the ring 104 described herein are only example device electronics. As such, the types of electronic components used to implement the device electronics may vary based on design considerations.

The functions attributed to the modules of the ring 104 described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 230-a of the ring 104 may include one or more processors (e.g., processing units), microcontrollers, digital signal processors, systems on a chip (SOCs), and/or other processing devices. The processing module 230-a communicates with the modules included in the ring 104. For example, the processing module 230-a may transmit/receive data to/from the modules and other components of the ring 104, such as the sensors. As described herein, the modules may be implemented by various circuit components. Accordingly, the modules may also be referred to as circuits (e.g., a communication circuit and power circuit).

The processing module 230-a may communicate with the memory 215. The memory 215 may include computer-readable instructions that, when executed by the processing module 230-a, cause the processing module 230-a to perform the various functions attributed to the processing module 230-a herein. In some implementations, the processing module 230-a (e.g., a microcontroller) may include additional features associated with other modules, such as communication functionality provided by the communication module 220-a (e.g., an integrated Bluetooth Low Energy transceiver) and/or additional onboard memory 215.

The communication module 220-a may include circuits that provide wireless and/or wired communication with the user device 106 (e.g., communication module 220-b of the user device 106). In some implementations, the communication modules 220-a, 220-b may include wireless communication circuits, such as Bluetooth circuits and/or Wi-Fi circuits. In some implementations, the communication modules 220-a, 220-b can include wired communication circuits, such as Universal Serial Bus (USB) communication circuits. Using the communication module 220-a, the ring 104 and the user device 106 may be configured to communicate with each other. The processing module 230-a of the ring may be configured to transmit/receive data to/from the user device 106 via the communication module 220-a. Example data may include, but is not limited to, motion data, temperature data, pulse waveforms, heart rate data, HRV data, PPG data, and status updates (e.g., charging status, battery charge level, and/or ring 104 configuration settings). The processing module 230-a of the ring may also be configured to receive updates (e.g., software/firmware updates) and data from the user device 106.

The ring 104 may include a battery 210 (e.g., a rechargeable battery 210). An example battery 210 may include a Lithium-Ion or Lithium-Polymer type battery 210, although a variety of battery 210 options are possible. The battery 210 may be wirelessly charged. In some implementations, the ring 104 may include a power source other than the battery 210, such as a capacitor. The power source (e.g., battery 210 or capacitor) may have a curved geometry that matches the curve of the ring 104. In some aspects, a charger or other power source may include additional sensors that may be used to collect data in addition to, or that supplements, data collected by the ring 104 itself. Moreover, a charger or other power source for the ring 104 may function as a user device 106, in which case the charger or other power source for the ring 104 may be configured to receive data from the ring 104, store and/or process data received from the ring 104, and communicate data between the ring 104 and the servers 110.

In some aspects, the ring 104 includes a power module 225 that may control charging of the battery 210. For example, the power module 225 may interface with an external wireless charger that charges the battery 210 when interfaced with the ring 104. The charger may include a datum structure that mates with a ring 104 datum structure to create a specified orientation with the ring 104 during charging. The power module 225 may also regulate voltage(s) of the device electronics, regulate power output to the device electronics, and monitor the state of charge of the battery 210. In some implementations, the battery 210 may include a protection circuit module (PCM) that protects the battery 210 from high current discharge, over voltage during charging, and under voltage during discharge. The power module 225 may also include electro-static discharge (ESD) protection.

The one or more temperature sensors 240 may be electrically coupled to the processing module 230-a. The temperature sensor 240 may be configured to generate a temperature signal (e.g., temperature data) that indicates a temperature read or sensed by the temperature sensor 240. The processing module 230-a may determine a temperature of the user in the location of the temperature sensor 240. For example, in the ring 104, temperature data generated by the temperature sensor 240 may indicate a temperature of a user at the user's finger (e.g., skin temperature). In some implementations, the temperature sensor 240 may contact the user's skin. In other implementations, a portion of the housing 205 (e.g., the inner housing 205-a) may form a barrier (e.g., a thin, thermally conductive barrier) between the temperature sensor 240 and the user's skin. In some implementations, portions of the ring 104 configured to contact the user's finger may have thermally conductive portions and thermally insulative portions. The thermally conductive portions may conduct heat from the user's finger to the temperature sensors 240. The thermally insulative portions may insulate portions of the ring 104 (e.g., the temperature sensor 240) from ambient temperature.

In some implementations, the temperature sensor 240 may generate a digital signal (e.g., temperature data) that the processing module 230-a may use to determine the temperature. As another example, in cases where the temperature sensor 240 includes a passive sensor, the processing module 230-a (or a temperature sensor 240 module) may measure a current/voltage generated by the temperature sensor 240 and determine the temperature based on the measured current/voltage. Example temperature sensors 240 may include a thermistor, such as a negative temperature coefficient (NTC) thermistor, or other types of sensors including resistors, transistors, diodes, and/or other electrical/electronic components.

The processing module 230-a may sample the user's temperature over time. For example, the processing module 230-a may sample the user's temperature according to a sampling rate. An example sampling rate may include one sample per second, although the processing module 230-a may be configured to sample the temperature signal at other sampling rates that are higher or lower than one sample per second. In some implementations, the processing module 230-a may sample the user's temperature continuously throughout the day and night. Sampling at a sufficient rate (e.g., one sample per second) throughout the day may provide sufficient temperature data for analysis described herein.

The processing module 230-a may store the sampled temperature data in memory 215. In some implementations, the processing module 230-a may process the sampled temperature data. For example, the processing module 230-a may determine average temperature values over a period of time. In one example, the processing module 230-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 215 may store the average temperature values over time. In some implementations, the memory 215 may store average temperatures (e.g., one per minute) instead of sampled temperatures in order to conserve memory 215.

The sampling rate, which may be stored in memory 215, may be configurable. In some implementations, the sampling rate may be the same throughout the day and night. In other implementations, the sampling rate may be changed throughout the day/night. In some implementations, the ring 104 may filter/reject temperature readings, such as large spikes in temperature that are not indicative of physiological changes (e.g., a temperature spike from a hot shower). In some implementations, the ring 104 may filter/reject temperature readings that may not be reliable due to other factors, such as excessive motion during exercise (e.g., as indicated by a motion sensor 245).

The ring 104 (e.g., communication module) may transmit the sampled and/or average temperature data to the user device 106 for storage and/or further processing. The user device 106 may transfer the sampled and/or average temperature data to the server 110 for storage and/or further processing.

Although the ring 104 is illustrated as including a single temperature sensor 240, the ring 104 may include multiple temperature sensors 240 in one or more locations, such as arranged along the inner housing 205-a near the user's finger. In some implementations, the temperature sensors 240 may be stand-alone temperature sensors 240. Additionally, or alternatively, one or more temperature sensors 240 may be included with other components (e.g., packaged with other components), such as with the accelerometer and/or processor.

The processing module 230-a may acquire and process data from multiple temperature sensors 240 in a similar manner described with respect to a single temperature sensor 240. For example, the processing module 230 may individually sample, average, and store temperature data from each of the multiple temperature sensors 240. In other examples, the processing module 230-a may sample the sensors at different rates and average/store different values for the different sensors. In some implementations, the processing module 230-a may be configured to determine a single temperature based on the average of two or more temperatures determined by two or more temperature sensors 240 in different locations on the finger.

The temperature sensors 240 on the ring 104 may acquire distal temperatures at the user's finger (e.g., any finger). For example, one or more temperature sensors 240 on the ring 104 may acquire a user's temperature from the underside of a finger or at a different location on the finger. In some implementations, the ring 104 may continuously acquire distal temperature (e.g., at a sampling rate). Although distal temperature measured by a ring 104 at the finger is described herein, other devices may measure temperature at the same/different locations. In some cases, the distal temperature measured at a user's finger may differ from the temperature measured at a user's wrist or other external body location. Additionally, the distal temperature measured at a user's finger (e.g., a “shell” temperature) may differ from the user's core temperature. As such, the ring 104 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The ring 104 may include a PPG system 235. The PPG system 235 may include one or more optical transmitters that transmit light. The PPG system 235 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user's finger. The PPG signal generated by the PPG system 235 may indicate the perfusion of blood in the illuminated region. For example, the PPG signal may indicate blood volume changes in the illuminated region caused by a user's pulse pressure. The processing module 230-a may sample the PPG signal and determine a user's pulse waveform based on the PPG signal. The processing module 230-a may determine a variety of physiological parameters based on the user's pulse waveform, such as a user's respiratory rate, heart rate, HRV, oxygen saturation, and other circulatory parameters.

In some implementations, the PPG system 235 may be configured as a reflective PPG system 235 where the optical receiver(s) receive transmitted light that is reflected through the region of the user's finger. In some implementations, the PPG system 235 may be configured as a transmissive PPG system 235 where the optical transmitter(s) and optical receiver(s) are arranged opposite to one another, such that light is transmitted directly through a portion of the user's finger to the optical receiver(s).

The number and ratio of transmitters and receivers included in the PPG system 235 may vary. Example optical transmitters may include light-emitting diodes (LEDs). The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 235. The optical receivers and optical transmitters may transmit and receive light through one or more apertures and protrusions in the inner housing 205-a as described herein.

The PPG system 235 illustrated in FIG. 2 may include a reflective PPG system 235 in some implementations. In these implementations, the PPG system 235 may include a centrally located optical receiver (e.g., at the bottom of the ring 104) and two optical transmitters located on each side of the optical receiver. In this implementation, the PPG system 235 (e.g., optical receiver) may generate the PPG signal based on light received from one or both of the optical transmitters. In other implementations, other placements, combinations, and/or configurations of one or more optical transmitters and/or optical receivers are contemplated.

The processing module 230-a may control one or both of the optical transmitters to transmit light while sampling the PPG signal generated by the optical receiver. In some implementations, the processing module 230-a may cause the optical transmitter with the stronger received signal to transmit light while sampling the PPG signal generated by the optical receiver. For example, the selected optical transmitter may continuously emit light while the PPG signal is sampled at a sampling rate (e.g., 250 Hz).

Sampling the PPG signal generated by the PPG system 235 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 230-a may store the pulse waveform in memory 215 in some implementations. The processing module 230-a may process the pulse waveform as it is generated and/or from memory 215 to determine user physiological parameters described herein.

The processing module 230-a may determine the user's heart rate based on the pulse waveform. For example, the processing module 230-a may determine heart rate (e.g., in beats per minute) based on the time between peaks in the pulse waveform. The time between peaks may be referred to as an interbeat interval (IBI). The processing module 230-a may store the determined heart rate values and IBI values in memory 215.

The processing module 230-a may determine HRV over time. For example, the processing module 230-a may determine HRV based on the variation in the IBIs. The processing module 230-a may store the HRV values over time in the memory 215. Moreover, the processing module 230-a may determine the user's respiratory rate over time. For example, the processing module 230-a may determine respiratory rate based on frequency modulation, amplitude modulation, or baseline modulation of the user's IBI values over a period of time. Respiratory rate may be calculated in breaths per minute or as another breathing rate (e.g., breaths per 30 seconds). The processing module 230-a may store user respiratory rate values over time in the memory 215.

The ring 104 may include one or more motion sensors 245, such as one or more accelerometers (e.g., 6-D accelerometers) and/or one or more gyroscopes (gyros). The motion sensors 245 may generate motion signals that indicate motion of the sensors. For example, the ring 104 may include one or more accelerometers that generate acceleration signals that indicate acceleration of the accelerometers. As another example, the ring 104 may include one or more gyro sensors that generate gyro signals that indicate angular motion (e.g., angular velocity) and/or changes in orientation. The motion sensors 245 may be included in one or more sensor packages. An example accelerometer/gyro sensor is a Bosch BM1160 inertial micro electro-mechanical system (MEMS) sensor that may measure angular rates and accelerations in three perpendicular axes.

The processing module 230-a may sample the motion signals at a sampling rate (e.g., 50 Hz) and determine the motion of the ring 104 based on the sampled motion signals. For example, the processing module 230-a may sample acceleration signals to determine acceleration of the ring 104. As another example, the processing module 230-a may sample a gyro signal to determine angular motion. In some implementations, the processing module 230-a may store motion data in memory 215. Motion data may include sampled motion data as well as motion data that is calculated based on the sampled motion signals (e.g., acceleration and angular values).

The ring 104 may store a variety of data described herein. For example, the ring 104 may store temperature data, such as raw sampled temperature data and calculated temperature data (e.g., average temperatures). As another example, the ring 104 may store PPG signal data, such as pulse waveforms and data calculated based on the pulse waveforms (e.g., heart rate values, IBI values, HRV values, and respiratory rate values). The ring 104 may also store motion data, such as sampled motion data that indicates linear and angular motion.

The ring 104, or other computing device, may calculate and store additional values based on the sampled/calculated physiological data. For example, the processing module 230 may calculate and store various metrics, such as sleep metrics (e.g., a Sleep Score), activity metrics, and readiness metrics. In some implementations, additional values/metrics may be referred to as “derived values.” The ring 104, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the ring 104 is oriented on the user's finger and if the ring 104 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 230-a may compress the data stored in memory 215. For example, the processing module 230-a may delete sampled data after making calculations based on the sampled data. As another example, the processing module 230-a may average data over longer periods of time in order to reduce the number of stored values. In a specific example, if average temperatures for a user over one minute are stored in memory 215, the processing module 230-a may calculate average temperatures over a five minute time period for storage, and then subsequently erase the one minute average temperature data. The processing module 230-a may compress data based on a variety of factors, such as the total amount of used/available memory 215 and/or an elapsed time since the ring 104 last transmitted the data to the user device 106.

Although a user's physiological parameters may be measured by sensors included on a ring 104, other devices may measure a user's physiological parameters. For example, although a user's temperature may be measured by a temperature sensor 240 included in a ring 104, other devices may measure a user's temperature. In some examples, other wearable devices (e.g., wrist devices) may include sensors that measure user physiological parameters. Additionally, medical devices, such as external medical devices (e.g., wearable medical devices) and/or implantable medical devices, may measure a user's physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the ring 104 can make physiological measurements in a resting/sleep state in order to acquire cleaner physiological signals. In one example, the ring 104 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the ring 104 may be configured to collect, store, and/or process data, and may transfer any of the data described herein to the user device 106 for storage and/or processing. In some aspects, the user device 106 includes a wearable application 250, an operating system (OS), a web browser application (e.g., web browser 280), one or more additional applications, and a GUI 275. The user device 106 may further include other modules and components, including sensors, audio devices, haptic feedback devices, and the like. The wearable application 250 may include an example of an application (e.g., “app”) that may be installed on the user device 106. The wearable application 250 may be configured to acquire data from the ring 104, store the acquired data, and process the acquired data as described herein. For example, the wearable application 250 may include a user interface (UI) module 255, an acquisition module 260, a processing module 230-b, a communication module 220-b, and a storage module (e.g., database 265) configured to store application data.

In some cases, the wearable device 104 and the user device 106 may be included within (or make up) the same device. For example, in some cases, the wearable device 104 may be configured to execute the wearable application 250, and may be configured to display data via the GUI 275.

The various data processing operations described herein may be performed by the ring 104, the user device 106, the servers 110, or any combination thereof. For example, in some cases, data collected by the ring 104 may be pre-processed and transmitted to the user device 106. In this example, the user device 106 may perform some data processing operations on the received data, may transmit the data to the servers 110 for data processing, or both. For instance, in some cases, the user device 106 may perform processing operations that require relatively low processing power and/or operations that require a relatively low latency, whereas the user device 106 may transmit the data to the servers 110 for processing operations that require relatively high processing power and/or operations that may allow relatively higher latency.

In some aspects, the ring 104, user device 106, and server 110 of the system 200 may be configured to evaluate sleep patterns for a user. In particular, the respective components of the system 200 may be used to collect data from a user via the ring 104, and generate one or more scores (e.g., Sleep Score, Readiness Score) for the user based on the collected data. For example, as noted previously herein, the ring 104 of the system 200 may be worn by a user to collect data from the user, including temperature, heart rate, HRV, and the like. Data collected by the ring 104 may be used to determine when the user is asleep in order to evaluate the user's sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the ring 104 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 200 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user's overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user's sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user's overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user's needs. Typically, adults need 7-9 hours of sleep a night to stay healthy, alert, and to perform at their best both mentally and physically. However, it is normal to have an occasional night of bad sleep, so the sleep balance contributor takes into account long-term sleep patterns to determine whether each user's sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user's resting heart rate to stabilize during the night. A sign of a very good recovery is that the user's resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user's highest temperature during the nap is at least 0.5° C. higher than the highest temperature during the longest period. In some aspects, the ring may measure a user's body temperature while the user is asleep, and the system 200 may display the user's average temperature relative to the user's baseline temperature. If a user's body temperature is outside of their normal range (e.g., clearly above or below 0.0), the body temperature contributor may be highlighted (e.g., go to a “Pay attention” state) or otherwise generate an alert for the user.

In some aspects, the system 200 may support techniques for manufacturing wearable devices using molding processes (e.g., vacuum molding processes, pressure molding processes). In particular, the wearable device 104 of the system 200 may include one or more protrusions extending from the inner housing 205-a, where the protrusions are formed via vacuum-forming processes and/or pressure-forming processes. For example, a moldable material (e.g., PMMA, PC, PET, and/or PA) may be heated and vacuum-formed in a mold to form the protrusions that extend from the inner housing 205-a. Additionally, or alternatively, the vacuum forming process may be used to form flat “windows” from the moldable material, where the flat windows may be used to facilitate physiological data collection, charging (e.g., inductive charging), wireless communications (e.g., NFC or Bluetooth communications), or any combination thereof. Additionally, or alternatively, the moldable material may be molded to form the protrusions based on pressure molding (e.g., by extruding the moldable material through apertures using pressure, such as in a pressure machine). The moldable material may form the inner housing 205-a of the wearable device 104, or may be adhered to the inner housing 205-a of the wearable device (e.g., prior to vacuum or pressure molding) such that the vacuum-formed protrusions are extruded through apertures of the inner housing 205-a of the wearable device 104. The PCB (e.g., including the one or more sensors and the charging components) and an outer housing 205-b of the wearable device 104 may accordingly be adhered to the inner housing 205-a and the moldable material. In some examples, one or more of the protrusions may be flat (e.g., level to a surface of the inner housing 205-a).

In some aspects, the moldable material used for the vacuum molding and/or pressure molding process may be optically clear (e.g., in one or more radial locations corresponding to sensors of the PPG system 235 or charging components of the wearable device) or may be a colored translucent or transparent material (e.g., in one or more radial locations corresponding to charging components of the wearable device). The moldable material may be a single continuous piece of moldable material, or may be multiple separate pieces of moldable materials (e.g., a separate piece of moldable material forming each protrusion, or a first piece of moldable forming protrusions over the one or more sensors and a second piece of moldable material forming a protrusion over the charging component).

In some examples, the vacuum or pressure-formed protrusions extending from the inner housing 205-a may be unfilled (e.g., filled with air) or may be filled with another optically clear material (e.g., epoxy). For example, a manufacturing process may include manufacturing a hole in the vacuum-formed protrusions (e.g., after forming the protrusions) and filling the protrusions with the optically clear material via the hole after adhering the PCB (e.g., including the one or more sensors and the charging components) to the moldable material. Additionally, or alternatively, the manufacturing process may include filling the protrusions with the optically clear material after adhering the PCB (e.g., including the one or more sensors and the charging components) to the moldable material via one or more holes in an adhesive material (e.g., glue), in the PCB, or both. Additionally, or alternatively, the manufacturing process may include partially filling the protrusions with the optically clear material prior to adhering the PCB (e.g., including the one or more sensors and the charging components) to the moldable material.

In some examples, the vacuum-or pressure-formed protrusions may be formed around the inner housing 205-a. For example, the moldable material forming the protrusions may be molded to surround the inner housing 205-a (e.g., rather than through apertures in the inner housing 205-a). In such examples, the protrusions may be molded against the sensors (e.g., without an air pocket within a cavity formed by the protrusion) or spaced from the sensors (e.g., with an air pocket within a cavity formed by the protrusion).

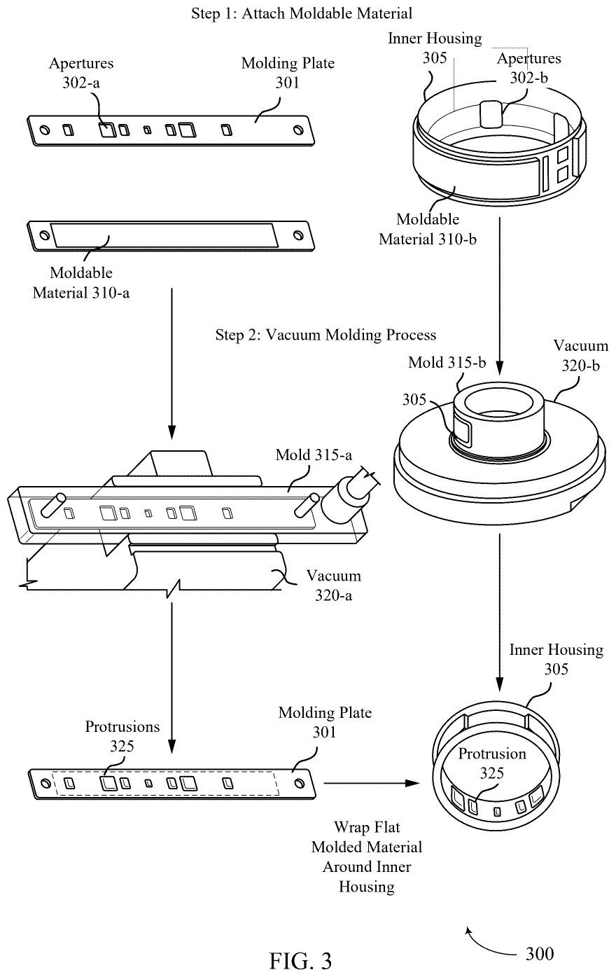

FIG. 3 shows an example of a manufacturing diagram 300 that supports techniques for manufacturing a wearable device using vacuum-formed and/or pressure-formed domes/protrusions in accordance with aspects of the present disclosure. The manufacturing diagram 300 may implement, or may be implemented by, one or more aspects of the system 100, the system 200, or both. For example, the manufacturing diagram 300 may illustrate a manufacturing process for one or more components of a wearable device, which may be an example of a wearable device 104 as described herein with reference to FIG. 1 and FIG. 2.

In some examples, a wearable device 104 (e.g., a wearable ring device) may include one or more protrusions 325 that protrude from an inner housing 305 of the wearable device 104 (e.g., a cover). As noted previously herein, it has been found that such protrusions 325 may help improve contact with a tissue of a user, and may therefore improve the quality of collected physiological measurements.

As noted previously herein, in some conventional approaches, the inner housing 305 and/or the protrusions 325 may be formed via an epoxy molding process, where the epoxy material is molded over a PCB of the wearable device 104. However, such epoxy molding processes require complex molds, and are difficult to perform. As such, these epoxy molding processes often result in cracks or other defects within the epoxy material.

Accordingly, aspects of the present disclosure are directed to manufacturing techniques that utilize molding processes (e.g., vacuum molding, pressure molding) to form the protrusions 325 that extend from the inner housing 305. The one or more protrusions 325 may be formed from an optically clear, transparent, or translucent moldable material 310 (e.g., foil, PMMA, PC, PET, and/or PA) via a vacuum molding procedure and/or pressure molding procedure as described herein. Accordingly, the wearable device may perform measurements (e.g., using one or more sensors such as light-emitting components and light-receiving components) and charge a rechargeable battery of the wearable device through the one or more protrusions 325.

There are two primary implementations for performing the vacuum molding and/or pressure molding processes described herein, as shown in the two “columns” in FIG. 3. In a first implementation, as shown in the left column, the vacuum/pressure molding process may be performed to form the protrusions 325 on/within a molding plate 301, where the molded protrusions 325 may be subsequently attached to the inner housing 305. In a second implementation, as shown in the right column, the vacuum/pressure molding process may be performed to form the protrusions 325 directly on/within the inner housing 305. Each of these implementations will be described in further detail herein.

Reference will first be made to the first implementation shown and described in the left column of FIG. 3. In a first step, the moldable material 310 may be adhered to a surface of a molding plate 301. In some cases, the moldable material 310 may be attached to the molding plate 301 using an adhesive material (e.g., a double-side adhesive, glue). As shown in FIG. 3, the molding plate 301 may include one or more apertures 302-a. The arrangement and/or size of the apertures 302-a of the molding plate 301 may substantially correspond to the arrangement and/or size of the apertures 302-b of an inner housing 305 of a wearable ring device 104. In this regard, the protrusions 325 formed via the molding plate 301 may be subsequently adhered/attached to the inner housing 305, as will be further shown and described herein.

Continuing with reference to the first implementation shown in the left column, in a second step, the molding plate 301 and the moldable material 310-a may be placed into a mold 315-a that will be used to perform the vacuum molding process. A vacuum 320-a (and/or pump in the context of pressure molding) may be used to force portions of the moldable material 310-a through the one or more apertures 302-a of the molding plate 301, thereby forming the one or more protrusions through the apertures 302-a. That is, one or more vacuums 320 may apply a vacuum pressure to the moldable material 310-a to “suck” the moldable material 310-a into the indentations of the mold 315-a. For example, the one or more vacuums 320-a may cause the moldable material 310-a to extrude through the one or more apertures 302-a of the molding plate 301. The protrusions 325 may thereby extend through the molding plate 301 such that the protrusions 325 extend to a height equal to or greater than a surface of the molding plate 301. In some examples, the protrusions 325 may be formed using heat and pressured air and/or a heated pressing head (e.g., a heated material that may press the moldable material 310 into the indentations of the mold 315-a). In some aspects, the mold 315-a may include recesses or other structures that form the respective shape and size of the protrusions 325.

In some examples, the moldable material 310-a may be a single continuous piece of moldable material 310-a. The single piece of moldable material 310-a may be uniform (e.g., a uniform optically clear material) or may be non-uniform. In particular, in some cases, the moldable material 310-a may be made of an optically clear material in places that overlap the apertures 302-a and form the protrusions, and may be formed from an opaque material in other places. For example, one or more portions of the moldable material 310-a (e.g., portions in a same radial position of the wearable device as one or more sensors, such as light-emitting components (e.g., LEDs) and light-receiving components (e.g., photodiodes)) may be optically clear (e.g., transparent) may be optically clear and one or more portions of the moldable material 310 (e.g., portions in a same radial position of the wearable device as an inductive charging component and/or a serial number) are colored and/or translucent (e.g., infrared (IR) black). In such examples, one or more portions of the moldable material 310-a (e.g., portions in a different radial position of the wearable device as the sensors, the inductive charging component, and/or the serial number) may be opaque (e.g., a non-optically clear or translucent black material).

Continuing with reference to the first implementation in the left column, following the vacuum molding process (and/or pressure molding process) used to form the protrusions 325 (lower left corner in FIG. 3), the moldable material 310-a including the protrusions 325 may be detached from the molding plate 301 and wrapped around the inner housing 305 of the wearable ring device 104. In particular, the moldable material 310-a may be wrapped around the inner housing 305 such that the formed protrusions 325 are inserted into/through the apertures 302-a of the inner housing 305. In such cases, the apertures 302-a and the protrusions 325 may form “windows” that are usable to collect physiological data (e.g., via the one or more sensors). In additional or alternative implementations, the vacuum/pressure molding process may be used to perform substantially flat “windows” (instead of protrusions) that are aligned with inductive charging components of the wearable ring device that are used to charge a rechargeable battery of the wearable device (e.g., via the charging component).

Referring now to the second implementation, as shown in the right column of FIG. 3, the vacuum/pressure molding process may be performed to form the protrusions directly onto/within the inner housing 305. For example, in a first step, the moldable material 310-b may be attached to (e.g., wrapped around) the inner housing 305. As noted previously herein, the moldable material 310-a may include one or more different materials, such as optically-transparent materials, optically opaque materials, or both. For example, the moldable material 310-b may include optically-transparent portions that overlap with one or more apertures 302-b of the inner housing 305.

Continuing with the second implementation illustrated in the right column, in a second step, the inner housing 305 and the moldable material 310-b may be placed into a mold 315-b. As described previously herein, one or more vacuums 320-b (and/or pumps in the context of pressure molding) may be used to force portions of the moldable material 310-b through the one or more apertures 302-b to form the one or more protrusions 325. As such, the mold 315-b may include one or more recesses that form a shape and size of the protrusions 325. In this regard, in accordance with the second implementation, the protrusions 325 may be formed directly on/within the inner housing 305 to form the protrusions 325.

Following the vacuum/pressure molding process of either implementation, one or more components of the wearable device may be added (e.g., adhered) to the inner housing 305. For example, a PCB including the one or more sensors and the inductive charging component may be adhered to the formed inner housing 305 such that the one or more sensors and the inductive charging component align with the protrusions 325 (e.g., in the respective radial positions of the optically clear and colored optically transparent portions of the moldable material 310). An outer housing may be adhered to the formed inner housing 305 and/or the PCB to form the wearable device 104. Additionally, or alternatively, the PCB may be coupled with (e.g., adhered to) the inner housing 305 prior to forming the protrusions 325. In such examples, the moldable material 310 may be formed around (e.g., at least partially surrounding) the inner housing 305 and the PCB.

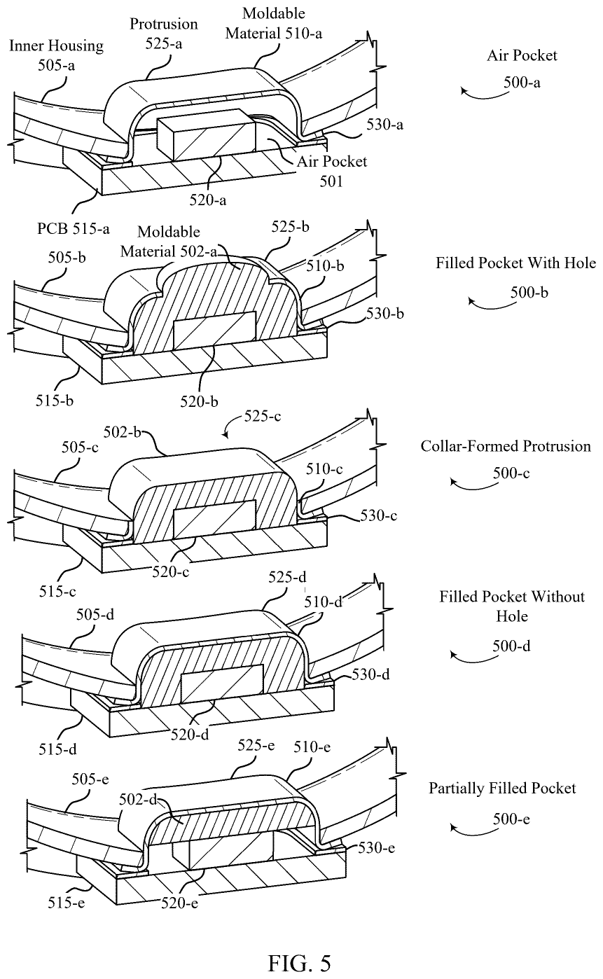

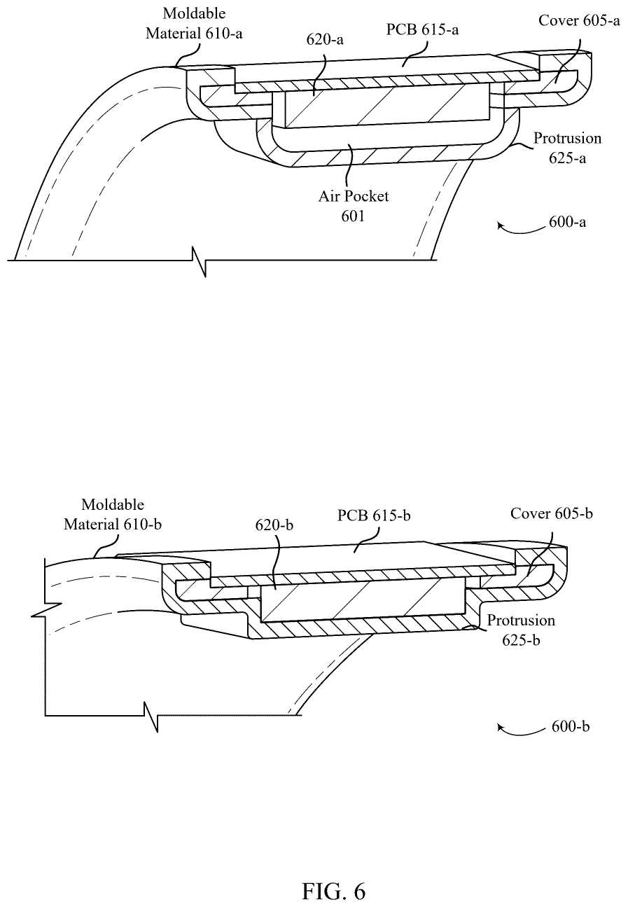

In some examples, the protrusions 325 may be hollow (e.g., non-filled, air-filled). In some examples, the protrusions 325 may be partially or fully filled with an additional moldable material (e.g., an optically clear material such as epoxy) prior to or after adhering the PCB to the formed inner housing 305. Accordingly, the protrusions 325 may be rigid or elastically deformable. Such techniques are described in further detail herein with reference to FIGS. 5 and 6.

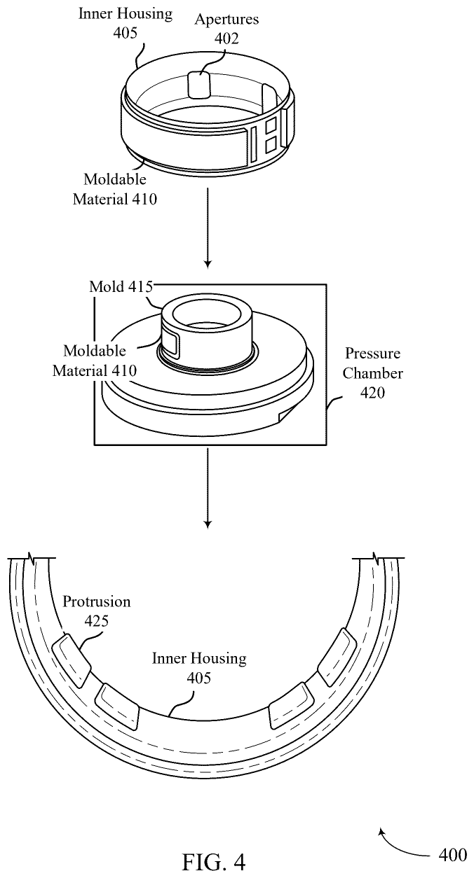

FIG. 4 shows an example of a manufacturing diagram 400 that supports techniques for manufacturing a wearable device using vacuum-formed and/or pressure-formed domes/protrusions in accordance with aspects of the present disclosure. The manufacturing diagram 400 may implement, or may be implemented by, one or more aspects of the system 100, the system 200, or the manufacturing diagram 300. For example, the manufacturing diagram 400 may illustrate a manufacturing process for one or more components of a wearable device, which may be an example of a wearable device 104 as described herein with reference to FIG. 1 and FIG. 2.

In some examples, as described with reference to FIG. 3, a wearable device 104 (e.g., a wearable ring device) may include one or more protrusions 425 that protrude from an inner housing 405 of the wearable device 104 (e.g., a cover). Some aspects of the present disclosure are directed to manufacturing techniques that utilize molding processes (e.g., pressure molding) to form the protrusions 425 that extend from the inner housing 405. The one or more protrusions 425 may be formed from an optically clear, transparent, or translucent moldable material 410 (e.g., foil, PMMA, PC, PET, and/or PA) via a vacuum molding procedure as described herein. Accordingly, the wearable device may perform measurements (e.g., using one or more sensors such as light-emitting components and light-receiving components) and charge a rechargeable battery of the wearable device through the one or more protrusions 425.

The pressure molding process may be performed to form the protrusions directly onto/within the inner housing 405. For example, in a first step, the moldable material 410 may be attached to (e.g., wrapped around) the inner housing 405. As noted previously herein, the moldable material 410 may include one or more different materials, such as optically-transparent materials, optically opaque materials, or both. For example, the moldable material 410 may include optically-transparent portions that overlap with one or more apertures 402 of the inner housing 405. In some cases, the moldable material 410 may be attached to the inner housing 405 using an adhesive material (e.g., a double-side adhesive, glue).

In a second step, the inner housing 405 and the moldable material 410 may be placed into a mold 415. As described previously herein, a pressure chamber 420 may be used to force portions of the moldable material 410 through the one or more apertures 402 to form the one or more protrusions 425 (e.g., by heating the moldable material 410 and/or exerting physical or air pressure against the moldable material 410). That is, a pressure chamber 420 may apply a pressure (e.g., air pressure, physical pressure) to the moldable material 410 to “push” the moldable material 410 into the indentations of the mold 415. Accordingly, the mold 415 may include one or more recesses that form a shape and size of the protrusions 425. In this regard, the protrusions 425 may be formed directly on/within the inner housing 405 to form the protrusions 425.

In some examples, the moldable material 410 may be a single continuous piece of moldable material 410. The single piece of moldable material 410 may be uniform (e.g., a uniform optically clear material) or may be non-uniform. In particular, in some cases, the moldable material 410 may be made of an optically clear material in places that overlap the apertures 402 and form the protrusions, and may be formed from an opaque material in other places. For example, one or more portions of the moldable material 310-a (e.g., portions in a same radial position of the wearable device as one or more sensors, such as light-emitting components (e.g., LEDs) and light-receiving components (e.g., photodiodes)) may be optically clear (e.g., transparent) may be optically clear and one or more portions of the moldable material 310 (e.g., portions in a same radial position of the wearable device as an inductive charging component and/or a serial number) are colored and/or translucent (e.g., IR black). In such examples, one or more portions of the moldable material 310-a (e.g., portions in a different radial position of the wearable device as the sensors, the inductive charging component, and/or the serial number) may be opaque (e.g., a non-optically clear or translucent black material).

Following the pressure molding process, one or more components of the wearable device may be added (e.g., adhered) to the inner housing 405. For example, a PCB including the one or more sensors and the inductive charging component may be adhered to the formed inner housing 405 such that the one or more sensors and the inductive charging component align with the protrusions 425 (e.g., in the respective radial positions of the optically clear and colored optically transparent portions of the moldable material 410). An outer housing may be adhered to the formed inner housing 405 and/or the PCB to form the wearable device 104. Additionally, or alternatively, the PCB may be coupled with (e.g., adhered to) the inner housing 405 prior to forming the protrusions 425. In such examples, the moldable material 410 may be formed around (e.g., at least partially surrounding) the inner housing 405 and the PCB.

In some examples, the protrusions 425 may be hollow (e.g., non-filled, air-filled). In some examples, the protrusions 425 may be partially or fully filled with an additional moldable material (e.g., an optically clear material such as epoxy) prior to or after adhering the PCB to the formed inner housing 405. Accordingly, the protrusions 425 may be rigid or elastically deformable. Such techniques are described in further detail herein with reference to FIGS. 5 and 6.

FIG. 5 shows examples of protrusion diagrams 500 that support techniques for manufacturing a wearable device using vacuum-formed and/or pressure-formed domes in accordance with aspects of the present disclosure. The protrusion diagrams 500 may implement, or may be implemented by, one or more aspects of the system 100, the system 200, the manufacturing diagram 300, the manufacturing diagram 400, or any combination thereof. For example, the protrusion diagrams 500 may illustrate one or more components of a wearable device, 104 which may be an example of a wearable device 104 as described herein with reference to FIGS. 1-3.

The protrusion diagrams 500-a, 500-b, 500-c, 500-d, and 500-e illustrate different implementations for manufacturing protrusions 525 that extend from an inner housing 505 (e.g., an inner housing 505-a, 505-b, 505-c, 505-d, 505-e) of a wearable ring device 104, as shown and described in FIGS. 3 and 4. As described previously herein, the protrusions 525-a, 525-b, 525-c, 525-d, 525-e may be formed from an optically clear, transparent, or translucent moldable material 510-a, 510-b, 510-c, 510-d, 510-e, such as foil, PMMA, PC, PET, and/or PA via a vacuum forming procedure and/or pressure molding procedure as described herein with reference to FIGS. 3 and 4. Moreover, the protrusions 525 may be ridged and/or elastically deformable.

The one or more protrusions 525 may substantially cover or fill apertures within the inner housing 505. As described previously herein, a PCB 515 (e.g., PCB 515-a, 515-b, 515-c, 515-d, 515-e) may be attached to the inner housing 505 following the vacuum and/or pressure molding process used to form the protrusions 525. In particular, the PCB 515 may be attached to the inner housing 505 such that one or more electrical components 520 (e.g., electrical component 520-a, 520-b, 520-c, 520-d, 520-e) disposed on the PCB 515 may be positioned though/within the apertures of the inner housing 505 and/or within the protrusions 525. The electrical components 520 may include, but are not limited to, LEDs and photodiodes, charging components, and the like. In some aspects, the PCB 515 may be adhered to the inner housing 505 and/or the moldable material 510 via an adhesive material 530 (e.g., adhesive material 530-a, 530-b, 530-c, 530-d, 530-e).

Referring to the first protrusion diagram 500-a, in some aspects, the protrusion 525-a may be hollow (e.g., unfilled, air filled, gas filled). For example, the protrusion 525 may form an air pocket 501 surrounding electrical component 520-a. In such examples, the manufacturing process for the wearable ring device 104 may not include filling the protrusion 525-a with any material following the vacuum and/or pressure forming procedure. Such techniques may have a relatively lower cost of production. The boundaries of the air pocket 501 may be formed via the protrusion 525-a, the adhesive material 530-a, and/or the PCB 515-a. In some examples, the adhesive material 530-a may be air-tight (e.g., such that the air in the air pocket 501 may not escape the air pocket 501).

Referring to the second protrusion diagram 500-b, in some aspects, the protrusion 525-b may be filled with an additional moldable material 502-a (e.g., an optically clear material such as epoxy) via a hole in the protrusion 525-a. For example, after the vacuum and/or pressure molding procedure, a hole may be created (e.g., cut, drilled) in the moldable material 510-b of the protrusion 525-b (e.g., on a top surface of the protrusion 525-b or another surface of the protrusion 525-b). After adhering the PCB 515-b to the inner housing 505-b, the additional moldable material 502-a may be placed (e.g., injected, dispensed) into the protrusion 525-b through the hole. The additional moldable material 502-a may form a rigid dome above the protrusion (e.g., due to surface energy or tension in the additional moldable material 502-a). Moreover, the additional moldable material 502-a may substantially fill the protrusion 525-b, thereby protecting the electrical components 520-b from moisture, particulates, and mechanical damage.

These techniques used to form the protrusions 525 (e.g., lenses) may offer several advantages over previous approaches. For example, some previous wearable devices may form protrusions/domes over optical components by dispensing a material directly over the optical components. In such cases, the dome/droplet shape of the protrusion may be defined by the contact between dispensed material and the base material (e.g., material on which the optical components are positioned, such as the PCB), and may therefore depend on the surface properties of the base material. Therefore, using these previous approaches, the dome/droplet shape may collapse, which may result in large variations in size and/or shape both between wearable devices, but also between domes/protrusions of the same wearable device.

Accordingly, as shown in the second protrusion diagram 500-b, a sheet material (e.g., moldable material 510-b) may be used to limit/control the shape of the dispensed material (e.g., moldable material 502-a) used to form the lens/dome. That is, the a sheet material (e.g., moldable material 510-b) may be used to control the final shape of the lens/protrusion 525, which may increase repeatability and accuracy across protrusions 525 within the same and/or different wearable devices.

Referring to the third protrusion diagram 500-c, in some aspects, after the vacuum molding process, the top of the protrusion 525-c may be cut or otherwise removed, leaving a “collar” of moldable material 510-c around a surface, edge, or lip of the aperture within the inner housing 505-c. For instance, the third protrusion diagram 500-c illustrates the outline of the protrusion 525-c that is removed, leaving a collar that is flush with an inner surface of the inner housing 505-c. After adhering the PCB 515-c to the inner housing 505-c, the additional moldable material 502-b may be placed (e.g., injected, dispensed) into the aperture, where the collar of moldable material 510-c (which is left after removal of the protrusion 525-c) forms a boundary for the additional moldable material 502-b. That is, the collar of moldable material 510-c may create a barrier between the inner housing 505-c and the additional moldable material 502-b, which may prevent the additional moldable material 502-b from spreading and may enable a surface tension of the additional moldable material 502-c to form a rigid dome shape over the electronic components 520-c. In other words, the mechanical properties of the collar of the moldable material 510-c may result in improved molding for the additional moldable material 502-b used to form a dome over the aperture. For instance, the material properties of the collar of the moldable material 510-c may enable the additional moldable material 502-b to form a larger (e.g., higher) dome (as compared to cases where the additional moldable material 502-b is molded directly to the inner housing 505-c).

Referring to the fourth protrusion diagram 500-d, in some aspects, the protrusion 525-d may be filled with an additional moldable material 502-c (e.g., an optically clear material such as epoxy) without forming a hole in the protrusion 525-d For example, after adhering the PCB 515-d to the inner housing 505-d, the additional moldable material 502-c may be placed (e.g., injected, dispensed) into the protrusion through one or more holes (e.g., channels) within the PCB 515-d and/or inner housing 505-d, around a side of the PCB 515-d, or any combination thereof. That is, as compared to the second protrusion diagram 500-b in which the additional moldable material 502-a is injected through a hole in the protrusion 525-b, the additional moldable material 502-c in the fourth protrusion diagram 500-d may be injected into the protrusion 525-d without such a hole in the protrusion 525-d.

Referring to the fifth protrusion diagram 500-e, in some aspects, the protrusion 525-e may be partially filled with an additional moldable material 502-d (e.g., an optically clear material such as epoxy). For example, prior to adhering the PCB 515-e to the inner housing 505-e, the additional moldable material 502-d may be placed (e.g., injected) into the protrusion 525-e. A volume of the additional moldable material 502-d may be relatively less than a volume of the protrusion 525-e such that the additional moldable material 502-d only partially fills the protrusion 525-d. For instance, the additional moldable material 502-d may fill only a distal end of the protrusion 525-e, where the remainder of the protrusion includes an air pocket. That is, a bottom surface of the additional moldable material 502-d may extend a first depth in the protrusion 525-e that is less than a total depth of the protrusion 525-e. In some examples, after adhering the PCB 515-e to the inner housing 535-e, the bottom surface of the additional moldable material 502-d may be in contact with the electrical component 520-e. Such contact may increase an optical performance of the electrical component 520-e, and may protect the electrical components 520-e from damage (e.g., protection from moisture, particulates, and pressure).

FIG. 6 shows examples of protrusion diagrams 600 that support techniques for manufacturing a wearable device using vacuum-formed and/or pressure-formed domes in accordance with aspects of the present disclosure. The protrusion diagrams 600 may implement, or may be implemented by, one or more aspects of the system 100, the system 200, the manufacturing diagram 300, the manufacturing diagram 400, the protrusion diagrams 500, or any combination thereof. For example, the protrusion diagrams 600 may illustrate one or more components of a wearable device, 104 which may be an example of a wearable device 104 as described herein with reference to FIGS. 1-3.

The protrusion diagrams 600-a and 600-b illustrate different implementations for manufacturing protrusions 625 that are formed from a moldable material 610 that may at least partially surround an inner cover 605 (e.g., cover 605-a, cover 605-b) of a wearable ring device 104. Such a moldable material 610 may be molded to form the protrusions 625 according to a vacuum molding or pressure molding procedure, as described herein with reference to FIGS. 3 and 4. As described previously herein, the protrusions 625-a and 625-b may be formed from an optically clear, transparent, or translucent moldable material 610-a or 610-b, such as foil, PMMA, PC, PET, and/or PA via a vacuum forming procedure as described herein with reference to FIG. 3. Moreover, the protrusions 625 may be ridged and/or elastically deformable.

The one or more protrusions 625 may substantially cover or fill apertures within the cover 605. As described previously herein, a PCB 615 (e.g., PCB 615-a, 615-b) may be attached to the cover 605 following or prior to the vacuum molding process used to form the protrusions 625. In particular, the PCB 615 may be attached to the cover 605 such that one or more electrical components 620 (e.g., electrical component 620-a, 520-b) disposed on the PCB 615 may be positioned though/within the apertures of the cover 605 and/or within the protrusions 625. The electrical components 620 may include, but are not limited to, LEDs and photodiodes, charging components, and the like. In some aspects, the PCB 615 may be adhered to the cover 605 and/or the moldable material 610 via an adhesive material.

Referring to the first protrusion diagram 600-a, the wearable ring device may include a protrusion 625-a that is created by using a plastic sheet (e.g., moldable material 610-a) that is formed against an cover 605-a (e.g., inner cover made of metal, plastic, etc.), and molding the plastic sheet using a vacuum molding and/or pressure molding process described herein. For instance, the PCB 615-a, electrical components 620-a, and the plastic sheet (e.g., moldable material) may be placed into a mold, where a vacuum molding process and/or pressure molding process is used to force portions of the plastic sheet (e.g., moldable material) through the apertures of the mold to create the protrusions 625. In such cases, the molded plastic sheet may form the inner surface of the ring that contacts the user's finger.

As described previously herein, the protrusion 625-a may be hollow (e.g., unfilled, air filled, gas filled). For example, the protrusion 625 may form an air pocket 601 surrounding electrical component 620-a. In such examples, the manufacturing process for the wearable ring device 104 may not include filling the protrusion 625-a with any material following the vacuum forming procedure. Such techniques may have a relatively lower cost of production. The boundaries of the air pocket 601 may be formed via the protrusion 625-a and/or the PCB 615-a. In some examples, the adhesive material may be air-tight (e.g., such that the air in the air pocket 601 may not escape the air pocket 601).

Referring to the second protrusion diagram 600-b, the plastic sheet (e.g., moldable material 610-b) may be formed directly against the cover 605-b and the electrical components 620-b (e.g., using vacuum molding, pressure molding, thermal molding, etc.). In such cases, as described with reference to the first protrusion diagram 600-a, the molded plastic sheet may form the inner surface of the ring that contacts the user's finger.

In this example, the protrusion 625-b may be formed without an air pocket 601. That is, the protrusion 625-b may be formed around the electrical component 620-b such that the protrusion 625-b is in the shape of the electrical component 620-b (e.g., without a pocket or additional material forming an interior of the protrusion 625-b). The moldable material 610-b may accordingly form a seal around the electrical component 620-b, thereby protecting the electrical components 520-b from moisture, particulates, and mechanical damage. In such examples, the PCB 615-a may be coupled with the cover 605-b prior to the molding process to form the protrusion 625-b via molding the moldable material 610-b around the cover 605-b and the PCB 615-b.

In some aspects, the wearable ring devices shown and described in the protrusion diagrams 600 may be completed by attaching an outer housing around the ring. That is, an outer housing may be attached to the molded/cured moldable material 610, such as by using an adhesive, side covers, etc. In this regard, the PCB 615 and electrical components 620 may be secured within the ring between the molded/cured moldable material 610 and the outer housing.

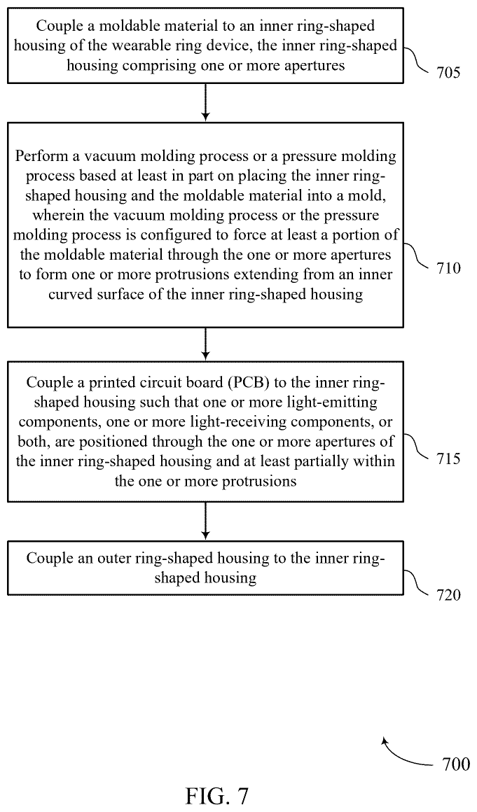

FIG. 7 shows a flowchart illustrating a method 700 that supports techniques for manufacturing a wearable device using vacuum-formed and/or pressure-formed domes in accordance with aspects of the present disclosure. The operations of the method 700 may be implemented by a wearable device or its components as described herein. For example, the operations of the method 700 may be performed by a wearable device as described with reference to FIGS. 1 through 6. In some examples, a wearable device may execute a set of instructions to control the functional elements of the wearable device to perform the described functions. Additionally, or alternatively, the wearable device may perform aspects of the described functions using special-purpose hardware.

At 705, the method may include coupling a moldable material to an inner ring-shaped housing of the wearable ring device, the inner ring-shaped housing comprising one or more apertures. The operations of 705 may be performed in accordance with examples as disclosed herein.

At 710, the method may include performing a vacuum molding process or a pressure molding process based at least in part on placing the inner ring-shaped housing and the moldable material into a mold, wherein the vacuum molding process or the pressure molding process is configured to force at least a portion of the moldable material through the one or more apertures to form one or more protrusions extending from an inner curved surface (e.g., inner circumferential surface) of the inner ring-shaped housing. The operations of 710 may be performed in accordance with examples as disclosed herein.

At 715, the method may include coupling a PCB to the inner ring-shaped housing such that one or more light-emitting components, one or more light-receiving components, or both, are positioned through the one or more apertures of the inner ring-shaped housing and at least partially within the one or more protrusions. The operations of 715 may be performed in accordance with examples as disclosed herein.

At 720, the method may include coupling an outer ring-shaped housing to the inner ring-shaped housing. The operations of 720 may be performed in accordance with examples as disclosed herein.

It should be noted that the methods described above describe possible implementations, and that the operations and the steps may be rearranged or otherwise modified and that other implementations are possible. Furthermore, aspects from two or more of the methods may be combined.

A method for manufacturing a wearable ring device by an apparatus is described. The method may include coupling a moldable material to an inner ring-shaped housing of the wearable ring device, the inner ring-shaped housing comprising one or more apertures, performing a vacuum molding process based at least in part on placing the inner ring-shaped housing and the moldable material into a mold, wherein the vacuum molding process or the pressure molding process is configured to force at least a portion of the moldable material through the one or more apertures to form one or more protrusions extending from an inner curved surface (e.g., inner circumferential surface) of the inner ring-shaped housing, coupling a PCB to the inner ring-shaped housing such that one or more light-emitting components, one or more light-receiving components, or both, are positioned through the one or more apertures of the inner ring-shaped housing and at least partially within the one or more protrusions, and coupling an outer ring-shaped housing to the inner ring-shaped housing.

An apparatus for manufacturing a wearable ring device is described. The apparatus may include one or more memories storing processor executable code, and one or more processors coupled with the one or more memories. The one or more processors may individually or collectively be operable to execute the code to cause the apparatus to couple a moldable material to an inner ring-shaped housing of the wearable ring device, the inner ring-shaped housing comprising one or more apertures, perform a vacuum molding process based at least in part on placing the inner ring-shaped housing and the moldable material into a mold, wherein the vacuum molding process or the pressure molding process is configured to force at least a portion of the moldable material through the one or more apertures to form one or more protrusions extending from an inner curved surface of the inner ring-shaped housing, couple a PCB to the inner ring-shaped housing such that one or more light-emitting components, one or more light-receiving components, or both, are positioned through the one or more apertures of the inner ring-shaped housing and at least partially within the one or more protrusions, and couple an outer ring-shaped housing to the inner ring-shaped housing.

Another apparatus for manufacturing a wearable ring device is described. The apparatus may include means for coupling a moldable material to an inner ring-shaped housing of the wearable ring device, the inner ring-shaped housing comprising one or more apertures, means for performing a vacuum molding process or a pressure molding process based at least in part on placing the inner ring-shaped housing and the moldable material into a mold, wherein the vacuum molding process or the pressure molding process is configured to force at least a portion of the moldable material through the one or more apertures to form one or more protrusions extending from an inner curved surface of the inner ring-shaped housing, means for coupling a PCB to the inner ring-shaped housing such that one or more light-emitting components, one or more light-receiving components, or both, are positioned through the one or more apertures of the inner ring-shaped housing and at least partially within the one or more protrusions, and means for coupling an outer ring-shaped housing to the inner ring-shaped housing.

A non-transitory computer-readable medium storing code for manufacturing a wearable ring device is described. The code may include instructions executable by one or more processors to couple a moldable material to an inner ring-shaped housing of the wearable ring device, the inner ring-shaped housing comprising one or more apertures, perform a vacuum molding process or a pressure molding process based at least in part on placing the inner ring-shaped housing and the moldable material into a mold, wherein the vacuum molding process or the pressure molding process is configured to force at least a portion of the moldable material through the one or more apertures to form one or more protrusions extending from an inner curved surface of the inner ring-shaped housing, couple a PCB to the inner ring-shaped housing such that one or more light-emitting components, one or more light-receiving components, or both, are positioned through the one or more apertures of the inner ring-shaped housing and at least partially within the one or more protrusions, and couple an outer ring-shaped housing to the inner ring-shaped housing.

Some examples of the method, apparatus, and non-transitory computer-readable medium described herein may further include operations, features, means, or instructions for coupling the PCB to the inner ring-shaped housing forms an air pocket within the one or more protrusions.

Some examples of the method, apparatus, and non-transitory computer-readable medium described herein may further include operations, features, means, or instructions for injecting an additional moldable material into the one or more protrusions after coupling the PCB to the inner ring-shaped housing such that the additional moldable material at least partially fills the one or more protrusions and covers the one or more light-emitting components, the one or more light-receiving components, or both, disposed within the one or more protrusions.

In some examples of the method, apparatus, and non-transitory computer-readable medium described herein, the additional moldable material may be injected into the one or more protrusions through a surface of the one or more protrusions.

In some examples of the method, apparatus, and non-transitory computer-readable medium described herein, the additional moldable material may be injected into the one or more protrusions through a hole in the PCB, around a side of the PCB, or both.

Some examples of the method, apparatus, and non-transitory computer-readable medium described herein may further include operations, features, means, or instructions for performing an additional molding process to fill a distal portion of the one or more protrusions with an additional moldable material, wherein the PCB may be coupled with the inner ring-shaped housing such that the one or more light-emitting components, the one or more light-receiving components, or both, contact the additional moldable material in the distal portion of the one or more protrusions.

In some examples of the method, apparatus, and non-transitory computer-readable medium described herein, the one or more protrusions substantially fill the one or more apertures based at least in part on performing the vacuum molding process.

In some examples of the method, apparatus, and non-transitory computer-readable medium described herein, the moldable material comprises a substantially transparent material and a substantially opaque material, the moldable material may be coupled with the inner ring-shaped housing such that the substantially transparent material may be aligned with the one or more apertures of the inner ring-shaped housing, and the one or more protrusions may be formed with the substantially transparent material.

In some examples of the method, apparatus, and non-transitory computer-readable medium described herein, the one or more protrusions comprise a rigid protrusion, an elastically deformable protrusion, or both.

In some examples of the method, apparatus, and non-transitory computer-readable medium described herein, the one or more apertures comprise a first aperture usable for physiological data collection and a second aperture usable for charging a battery of the wearable ring device, the one or more protrusions comprise a protrusion associated with the first aperture, and the vacuum molding process may be configured to form a window that substantially fills the second aperture.

In some examples of the method, apparatus, and non-transitory computer-readable medium described herein, the one or more apertures may be used for physiological data collection, charging a battery of the wearable ring device, or both.

A method by an apparatus is described. The method may include a housing comprising an inner ring-shaped housing and an outer ring-shaped housing, wherein the inner ring-shaped housing comprises a plurality of apertures and defines an inner curved surface of the wearable ring device, and wherein the outer ring-shaped housing defines an outer curved surface of the wearable ring device, a plurality of protrusions disposed within the plurality of apertures, the plurality of protrusions formed via a vacuum molding process or a pressure molding process that is configured to force a moldable material through the plurality of apertures, a PCB disposed within the housing, a plurality of electrical components disposed on the PCB, the plurality of electrical components comprising, and one or more light-emitting components, one or more light-receiving components, or both, disposed on a surface of the PCB and extending through the plurality of apertures such that the one or more light-emitting components, one or more light-receiving components, or both, are disposed at least partially within the plurality of protrusions.

An apparatus is described. The apparatus may include one or more memories storing processor executable code, and one or more processors coupled with the one or more memories. The one or more processors may individually or collectively be operable to execute the code to cause the apparatus to a housing comprise an inner ring-shaped housing and an outer ring-shaped housing, wherein the inner ring-shaped housing comprises a plurality of apertures and defines an inner curved surface of the wearable ring device, and wherein the outer ring-shaped housing defines an outer curved surface of the wearable ring device, a plurality of protrusions disposed within the plurality of apertures, the plurality of protrusions formed via a vacuum molding process or a pressure molding process that is configured to force a moldable material through the plurality of apertures, a PCB disposed within the housing, a plurality of electrical components dispose on the PCB, the plurality of electrical components comprising, and one or more light-emit components, one or more light-receiving components, or both, disposed on a surface of the PCB and extending through the plurality of apertures such that the one or more light-emitting components, one or more light-receiving components, or both, are disposed at least partially within the plurality of protrusions.

Another apparatus is described. The apparatus may include means for a housing comprising an inner ring-shaped housing and an outer ring-shaped housing, wherein the inner ring-shaped housing comprises a plurality of apertures and defines an inner curved surface of the wearable ring device, and wherein the outer ring-shaped housing defines an outer curved surface of the wearable ring device, means for a plurality of protrusions disposed within the plurality of apertures, the plurality of protrusions formed via a vacuum molding process or a pressure molding process that is configured to force a moldable material through the plurality of apertures, means for a PCB to be disposed within the housing, means for a plurality of electrical components disposed on the PCB, the plurality of electrical components comprising, and means for one or more light-emitting components, one or more light-receiving components, or both, disposed on a surface of the PCB and extending through the plurality of apertures such that the one or more light-emitting components, one or more light-receiving components, or both, are disposed at least partially within the plurality of protrusions.

A non-transitory computer-readable medium storing code is described. The code may include instructions executable by one or more processors to a housing comprise an inner ring-shaped housing and an outer ring-shaped housing, wherein the inner ring-shaped housing comprises a plurality of apertures and defines an inner curved surface of the wearable ring device, and wherein the outer ring-shaped housing defines an outer curved surface of the wearable ring device, a plurality of protrusions disposed within the plurality of apertures, the plurality of protrusions formed via a vacuum molding process or a pressure molding process that is configured to force a moldable material through the plurality of apertures, a PCB disposed within the housing, a plurality of electrical components dispose on the PCB, the plurality of electrical components comprising, and one or more light-emit components, one or more light-receiving components, or both, disposed on a surface of the PCB and extending through the plurality of apertures such that the one or more light-emitting components, one or more light-receiving components, or both, are disposed at least partially within the plurality of protrusions.

In some examples of the method, apparatus, and non-transitory computer-readable medium described herein, the plurality of protrusions comprise air pockets that surround the one or more light-emitting components, one or more light-receiving components, or both, disposed within the plurality of protrusions.

In some examples of the method, apparatus, and non-transitory computer-readable medium described herein, the plurality of protrusions comprise an additional moldable material that at least partially fills the plurality of protrusions and covers the one or more light-emitting components, the one or more light-receiving components, or both, disposed within the plurality of protrusions.

In some examples of the method, apparatus, and non-transitory computer-readable medium described herein, a distal portion of a protrusion of the plurality of protrusions may be filled with an additional moldable material and the PCB may be coupled with the inner ring-shaped housing such that the one or more light-emitting components, the one or more light-receiving components, or both, contact the additional moldable material in the distal portion of the protrusion.

In some examples of the method, apparatus, and non-transitory computer-readable medium described herein, the plurality of protrusions substantially fill the plurality of apertures based at least in part on the vacuum molding process.

In some examples of the method, apparatus, and non-transitory computer-readable medium described herein, the plurality of protrusions comprise a rigid protrusion, an elastically deformable protrusion, or both.

In some examples of the method, apparatus, and non-transitory computer-readable medium described herein, the plurality of apertures comprise a first aperture usable for physiological data collection and a second aperture usable for charging a battery of the wearable ring device, the plurality of protrusions comprise a protrusion associated with the first aperture, and the vacuum molding process may be configured to form a window that substantially fills the second aperture.

In some examples of the method, apparatus, and non-transitory computer-readable medium described herein, the plurality of apertures may be used for physiological data collection, charging a battery of the wearable ring device, or both.

Aspects of the present disclosure are set out below. Each item below corresponds to an aspect of the disclosure, and each possible combination of any of the items corresponds to an aspect of the disclosure. When items are combined, two or more instances of an element with the same name are to be understood as referring to the same element, even if the element is introduced by the word “a” more than once. Each possible combination of any features from the items below with any features described above also forms part of the disclosure:

Aspect 1: A method for manufacturing a wearable ring device, comprising: coupling a moldable material to an inner ring-shaped housing of the wearable ring device, the inner ring-shaped housing comprising one or more apertures; performing a vacuum molding process or a pressure molding process based at least in part on placing the inner ring-shaped housing and the moldable material into a mold, wherein the vacuum molding process or the pressure molding process is configured to force at least a portion of the moldable material through the one or more apertures to form one or more protrusions; coupling a PCB to the inner ring-shaped housing such that one or more light-emitting components, one or more light-receiving components, or both, are positioned through the one or more apertures of the inner ring-shaped housing and at least partially within the one or more protrusions; and coupling an outer ring-shaped housing to the inner ring-shaped housing.

It will be appreciated that the step of performing both a vacuum molding process and a pressure molding process may be carried out such that the pressure molding and vacuum molding are performed simultaneously, or such that the pressure molding and the vacuum molding are carried out at different times.

Aspect 2: The method of aspect 1, wherein coupling the PCB to the inner ring-shaped housing forms an air pocket within the one or more protrusions.

Aspect 3: The method of any of aspects 1 through 2, further comprising: injecting an additional moldable material into the one or more protrusions after coupling the PCB to the inner ring-shaped housing such that the additional moldable material at least partially fills the one or more protrusions and covers the one or more light-emitting components, the one or more light-receiving components, or both, disposed within the one or more protrusions.

Aspect 4: The method of aspect 3, wherein the additional moldable material is injected into the one or more protrusions through a surface of the one or more protrusions.

Aspect 5: The method of any of aspects 3 through 4, wherein the additional moldable material is injected into the one or more protrusions through a hole in the PCB, around a side of the PCB, or both.

Aspect 6: The method of any of aspects 1 through 5, further comprising: performing an additional molding process to fill a distal portion of the one or more protrusions with an additional moldable material, wherein the PCB is coupled with the inner ring-shaped housing such that the one or more light-emitting components, the one or more light-receiving components, or both, contact the additional moldable material in the distal portion of the one or more protrusions.

Aspect 7: The method of any of aspects 1 through 6, wherein the one or more protrusions substantially fill the one or more apertures based at least in part on performing the vacuum molding process or the pressure molding process.

Aspect 8: The method of any of aspects 1 through 7, wherein the moldable material comprises a substantially transparent material and a substantially opaque material, the moldable material is coupled with the inner ring-shaped housing such that the substantially transparent material is aligned with the one or more apertures of the inner ring-shaped housing, and the one or more protrusions are formed with the substantially transparent material.

Aspect 9: The method of any of aspects 1 through 8, wherein the one or more protrusions comprise a rigid protrusion, an elastically deformable protrusion, or both.

Aspect 10: The method of any of aspects 1 through 9, wherein the one or more apertures comprise a first aperture usable for physiological data collection and a second aperture usable for charging a battery of the wearable ring device, the one or more protrusions comprise a protrusion associated with the first aperture, and the vacuum molding process, the pressure molding process, or both, is configured to form a window that substantially fills the second aperture.

Aspect 11: The method of any of aspects 1 through 10, wherein the one or more apertures are used for physiological data collection, charging a battery of the wearable ring device, or both.

Aspect 12: The method of any of aspects 1 through 11, wherein the one or more protrusions extend from an inner curved surface of the inner ring-shaped housing, or the one or more protrusions substantially fill the one or more apertures such that the one or more protrusions are substantially flush with the inner curved surface of the inner ring-shaped housing.

Aspect 13: A wearable ring device, comprising: a housing comprising an inner ring-shaped housing and an outer ring-shaped housing, wherein the inner ring-shaped housing comprises a plurality of apertures and defines an inner curved surface of the wearable ring device, and wherein the outer ring-shaped housing defines an outer curved surface of the wearable ring device; a plurality of protrusions disposed within the plurality of apertures, the plurality of protrusions formed via a vacuum molding process or a pressure molding process that is configured to force a moldable material through the plurality of apertures; a PCB disposed within the housing; and a plurality of electrical components disposed on the PCB, the plurality of electrical components comprising: one or more light-emitting components, one or more light-receiving components, or both, disposed on a surface of the PCB and extending through the plurality of apertures such that the one or more light-emitting components, one or more light-receiving components, or both, are disposed at least partially within the plurality of protrusions.

Aspect 14: The wearable ring device of aspect 13, wherein the plurality of protrusions comprise air pockets that surround the one or more light-emitting components, one or more light-receiving components, or both, disposed within the plurality of protrusions.

Aspect 15: The wearable ring device of any of aspects 13 through 14 ,wherein the plurality of protrusions comprise an additional moldable material that at least partially fills the plurality of protrusions and covers the one or more light-emitting components, the one or more light-receiving components, or both, disposed within the plurality of protrusions.

Aspect 16: The wearable ring device of any of aspects 13 through 15, wherein a distal portion of a protrusion of the plurality of protrusions is filled with an additional moldable material, the PCB is coupled with the inner ring-shaped housing such that the one or more light-emitting components, the one or more light-receiving components, or both, contact the additional moldable material in the distal portion of the protrusion.

Aspect 17: The wearable ring device of any of aspects 13 through 16, wherein the plurality of protrusions substantially fill the plurality of apertures based at least in part on the vacuum molding process or the pressure molding process.

Aspect 18: The wearable ring device of any of aspects 13 through 17, wherein the plurality of protrusions comprise a rigid protrusion, an elastically deformable protrusion, or both.

Aspect 19: The wearable ring device of any of aspects 13 through 18, wherein the plurality of apertures comprise a first aperture usable for physiological data collection and a second aperture usable for charging a battery of the wearable ring device, the plurality of protrusions comprise a first protrusion associated with the first aperture, and the vacuum molding process or the pressure molding process is configured to form a window that substantially fills the second aperture.

Aspect 20: The wearable ring device of any of aspects 13 through 19, wherein the plurality of apertures are used for physiological data collection, charging a battery of the wearable ring device, or both.

Aspect 21: An apparatus for manufacturing a wearable ring device, comprising one or more memories storing processor-executable code, and one or more processors coupled with the one or more memories and individually or collectively operable to execute the code to cause the apparatus to perform a method of any of aspects 1 through 12.

Aspect 22: An apparatus for manufacturing a wearable ring device, comprising at least one means for performing a method of any of aspects 1 through 12.

Aspect 23: A non-transitory computer-readable medium storing code for manufacturing a wearable ring device, the code comprising instructions executable by one or more processors to perform a method of any of aspects 1 through 12.

Aspect 24: An apparatus comprising one or more memories storing processor-executable code, and one or more processors coupled with the one or more memories and individually or collectively operable to execute the code to cause the apparatus to perform a method of any of aspects 13 through 20.

Aspect 25: An apparatus comprising at least one means for performing a method of any of aspects 13 through 20.

Aspect 26: A non-transitory computer-readable medium storing code the code comprising instructions executable by one or more processors to perform a method of any of aspects 13 through 20.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for manufacturing a wearable ring device, comprising:
coupling a moldable material to an inner ring-shaped housing of the wearable ring device, the inner ring-shaped housing comprising one or more apertures;
performing a vacuum molding process or a pressure molding process based at least in part on placing the inner ring-shaped housing and the moldable material into a mold, wherein the vacuum molding process or the pressure molding process is configured to force at least a portion of the moldable material through the one or more apertures to form one or more protrusions;
coupling a printed circuit board (PCB) to the inner ring-shaped housing such that one or more light-emitting components, one or more light-receiving components, or both, are positioned through the one or more apertures of the inner ring-shaped housing and at least partially within the one or more protrusions; and
coupling an outer ring-shaped housing to the inner ring-shaped housing.

2. The method of claim 1, wherein coupling the PCB to the inner ring-shaped housing forms an air pocket within the one or more protrusions.

3. The method of claim 1, further comprising:
injecting an additional moldable material into the one or more protrusions after coupling the PCB to the inner ring-shaped housing such that the additional moldable material at least partially fills the one or more protrusions and covers the one or more light-emitting components, the one or more light-receiving components, or both, disposed within the one or more protrusions.

4. The method of claim 3, wherein the additional moldable material is injected into the one or more protrusions through a surface of the one or more protrusions.

5. The method of claim 3, wherein the additional moldable material is injected into the one or more protrusions through a hole in the PCB, around a side of the PCB, or both.

6. The method of claim 1, further comprising:
performing an additional molding process to fill a distal portion of the one or more protrusions with an additional moldable material, wherein the PCB is coupled with the inner ring-shaped housing such that the one or more light-emitting components, the one or more light-receiving components, or both, contact the additional moldable material in the distal portion of the one or more protrusions.

7. The method of claim 1, wherein the one or more protrusions substantially fill the one or more apertures based at least in part on performing the vacuum molding process or the pressure molding process.

8. The method of claim 1, wherein the moldable material comprises a substantially transparent material and a substantially opaque material, wherein the moldable material is coupled with the inner ring-shaped housing such that the substantially transparent material is aligned with the one or more apertures of the inner ring-shaped housing, and wherein the one or more protrusions are formed with the substantially transparent material.

9. The method of claim 1, wherein the one or more protrusions comprise a rigid protrusion, an elastically deformable protrusion, or both.

10. The method of claim 1, wherein the one or more apertures comprise a first aperture usable for physiological data collection and a second aperture usable for charging a battery of the wearable ring device, wherein the one or more protrusions comprise a protrusion associated with the first aperture, and wherein the vacuum molding process or the pressure molding process is configured to form a window that substantially fills the second aperture.

11. The method of claim 1, wherein the one or more apertures are used for physiological data collection, charging a battery of the wearable ring device, or both.

12. The method of claim 1, wherein the one or more protrusions extend from an inner curved surface of the inner ring-shaped housing, or wherein the one or more protrusions substantially fill the one or more apertures such that the one or more protrusions are substantially flush with the inner curved surface of the inner ring-shaped housing.

13. A wearable ring device, comprising:
a housing comprising an inner ring-shaped housing and an outer ring-shaped housing, wherein the inner ring-shaped housing comprises a plurality of apertures and defines an inner curved surface of the wearable ring device, and wherein the outer ring-shaped housing defines an outer curved surface of the wearable ring device;
a plurality of protrusions disposed within the plurality of apertures, the plurality of protrusions formed via a vacuum molding process or a pressure molding process that is configured to force a moldable material through the plurality of apertures;
a printed circuit board (PCB) disposed within the housing; and
a plurality of electrical components disposed on the PCB, the plurality of electrical components comprising:
one or more light-emitting components, one or more light-receiving components, or both, disposed on a surface of the PCB and extending through the plurality of apertures such that the one or more light-emitting components, one or more light-receiving components, or both, are disposed at least partially within the plurality of protrusions.

14. The wearable ring device of claim 13, wherein the plurality of protrusions comprise air pockets that surround the one or more light-emitting components, one or more light-receiving components, or both, disposed within the plurality of protrusions.

15. The wearable ring device of claim 13, wherein the plurality of protrusions comprise an additional moldable material that at least partially fills the plurality of protrusions and covers the one or more light-emitting components, the one or more light-receiving components, or both, disposed within the plurality of protrusions.

16. The wearable ring device of claim 13, wherein a distal portion of a protrusion of the plurality of protrusions is filled with an additional moldable material, wherein the PCB is coupled with the inner ring-shaped housing such that the one or more light-emitting components, the one or more light-receiving components, or both, contact the additional moldable material in the distal portion of the protrusion.

17. The wearable ring device of claim 13, wherein the plurality of protrusions substantially fill the plurality of apertures based at least in part on the vacuum molding process, the pressure molding process, or both.

18. The wearable ring device of claim 13, wherein the plurality of protrusions comprise a rigid protrusion, an elastically deformable protrusion, or both.

19. The wearable ring device of claim 13, wherein the plurality of apertures comprise a first aperture usable for physiological data collection and a second aperture usable for charging a battery of the wearable ring device, wherein the plurality of protrusions comprise a first protrusion associated with the first aperture, and wherein the vacuum molding process, the pressure molding process, or both, is configured to form a window that substantially fills the second aperture.

20. The wearable ring device of claim 13, wherein the plurality of apertures are used for physiological data collection, charging a battery of the wearable ring device, or both.
